(19) United States
(12) Patent Application Publication
(10) Pub. No.: US 2026/0216883 A1
(43) Pub. Date: Jul. 30, 2026

(54) Autonomous Food Preparation Robots With Adaptive Meal Assembly Controllers

(71) Applicant: SUMMITS, Inc., Santa Ana, CA (US)

(72) Inventor: Samuel Pisker, Santa Ana, CA (US)

(21) Appl. No.: 19/354,547

(22) Filed: Oct. 9, 2025

Related U.S. Application Data
(60) Provisional application No. 63/750,415, filed on Jan. 28, 2025.
(60) Provisional application No. 63/822,694, filed on Jun. 12, 2025.

(51) Int. Cl. B25J 11/00; A47J 44/00; B25J 9/16

(52) U.S. Cl. CPC B25J 11/008; A47J 44/00; B25J 9/1679

(57) ABSTRACT

A computer system that adaptively generates meal generation control programs for food production centers, such as food production centers utilizing autonomous meal preparation robots, via online ordering portals. The system combines ingredient-specific nutritional and culinary attributes with a user's health and fitness data to facilitate dynamic ingredient portion sizes and personalized meal recommendations, enabling users to achieve tailored nutritional outcomes.

### CROSS-REFERENCE TO RELATED APPLICATIONS

This application claims the benefit under 35 U.S.C. § 119(e) of U.S. Provisional Patent Application 63/750,415 (Attorney Docket No. SUMTP001P) by Samuel Pisker et al., titled: “Autonomous Food Preparation Robots With Adaptive Meal Assembly Controllers”, filed on 2025-01-28, and claims the benefit under 35 U.S.C. § 119(e) of U.S. Provisional Patent Application 63/822,694 (Attorney Docket No. SUMTP002P) by Samuel Pisker et al., titled: “Autonomous Food Preparation Robots With Adaptive Meal Assembly Controllers”, filed on 2025-06-12, both of which are incorporated herein by reference in their entireties for all purposes.

### FIELD OF TECHNOLOGY

This patent application relates generally to meal preparation systems, such as autonomous or semi-autonomous meal preparation systems, including autonomous meal preparation systems that utilize robots to provide for autonomous or semi-autonomous meal generation and/or food production.

### BACKGROUND

Custom meal production systems are gaining popularity in the food service industry for their efficiency and precision. These systems utilize systems that manage the assembly of meals. Meals for these systems are set recipes that are remotely ordered through online ordering platforms, such as websites, mobile applications, or in-store digital interfaces. These online ordering platforms provide recipes based on static pre-defined configurations for ingredient selections, combinations, and portion sizes.

### SUMMARY

Described are methods and systems for operating autonomous food preparation systems and/or robots.

Clause 1. An autonomous meal preparation robot, comprising: a communications module; a first meal preparation module, configured to perform a first meal preparation action; a second meal preparation module, configured to perform a second meal preparation action; an end effector, configured to receive a meal container; and a controller, comprising a processor and a non-transitory memory, the non-transitory memory configured to store instructions configured to cause the controller to: receive, with the communications module, a configuration request from a meal generator module; determine, based on the first meal preparation module and the second meal preparation module, a current configuration of the autonomous meal preparation robot; communicate, with the communications module, configuration data indicating the current configuration to the meal generator module; receive, based on the communicating the configuration data to the meal generator module, first meal data from the meal generator module; analyze the first meal data to determine a first meal generation sequence; receive, with the end effector, a first meal container; move, with the end effector, the first meal container to the first meal preparation module; perform, with the first meal preparation module, the first meal preparation action; move, with the end effector, the first meal container to the second meal preparation module; and perform, with the second meal preparation module, the second meal preparation action.

Clause 2. The autonomous meal preparation robot of clause 1, wherein the first meal preparation module is associated with a first ingredient, and wherein the second meal preparation module is associated with a second ingredient.

Clause 3. The autonomous meal preparation robot of clause 2, wherein the first meal preparation action comprises disposing the first ingredient within the first meal container.

Clause 4. The autonomous meal preparation robot of clause 3, wherein the first meal preparation module comprises a first vessel configured to obtain, measure, and dispose of the first ingredient.

Clause 5. The autonomous meal preparation robot of clause 4, wherein the second meal preparation action comprises disposing the second ingredient within the first meal container.

Clause 6. The autonomous meal preparation robot of clause 5, wherein the second meal preparation module comprises a second vessel configured to obtain, measure, and dispose of the second ingredient.

Clause 7. The autonomous meal preparation robot of clause 6, wherein the measuring of the first ingredient comprises measuring a weight of the first ingredient.

Clause 8. The autonomous meal preparation robot of clause 6, wherein the measuring of the first ingredient comprises measuring a volume of the first ingredient.

Clause 9. The autonomous meal preparation robot of clause 6, further comprising a third meal preparation module, configured to perform a third meal preparation action.

Clause 10. The autonomous meal preparation robot of clause 9, wherein the third meal preparation action comprises applying heat to the meal container.

Clause 11. A system comprising: a user database, configured to store user template data associated with a first user; a configuration database, configured to store meal generation templates; a communications module; a session module, configured to determine individual session payloads for individual meal generation indications; a meal generator module, wherein the system is configured to: receive, with the communications module and from a user device associated with the first user, first user data comprising a first meal generation indication; access, with the session module and based on receiving the first meal generation indication, the user database to obtain first user template data associated with the first user; determine, with the session module and based on the first user template data and the first user data, a first session payload associated with the first meal generation indication; communicate the first session payload to the meal generator module; select, with the meal generator module and based on receiving the first session payload, a first meal generation template from the configuration database; generate, with the meal generator module and based on the first session payload, first meal data in accordance with the first meal generation template; and communicate, with the communications module, the first meal data to the user device.

Clause 12. The system of clause 11, wherein the system is further configured to: receive, with the communications module from the user device, second user data indicating a user selection of the first meal data.

Clause 13. The system of clause 12, wherein the system is further configured to: communicate, with the communications module, the first meal data to a meal preparation system to cause the meal preparation system to prepare a first meal.

Clause 14. The system of clause 13, wherein the system is further configured to: delete the first session payload after communication of the first meal data to the meal preparation system.

Clause 15. The system of clause 13, wherein the meal preparation system comprises an autonomous meal preparation robot.

Clause 16. The system of clause 15, wherein the system is further configured to: receive, with the communications module, configuration data indicating a current configuration of the autonomous meal preparation robot, wherein the first session payload is determined based further on the configuration data.

Clause 17. The system of clause 11, wherein the system is further configured to: receive, with the communications module and from the user device, first fitness data; and store, within the user database, the first fitness data, wherein the determining the first session payload is further based on the first fitness data.

Clause 18. The system of clause 11, wherein the first meal generation template comprises: a first category target associated with a first ingredient category; and a second category target associated with a second ingredient category.

Clause 19. The system of clause 11, wherein the system is further configured to: receive, with the communications module from the user device, second user data indicating a user rejection of the first meal data; select, based on the user rejection, a second meal generation template from the configuration database; generate, with the meal generator module and based on the first session payload, second meal data in accordance with the second meal generation template; and communicate, with the communications module, the second meal data to the user device.

Clause 20. The system of clause 11, wherein the system is further configured to: select a second meal generation template from the configuration database; generate, with the meal generator module and based on the first session payload, second meal data in accordance with the second meal generation template; and communicate, with the communications module, the second meal data to the user device along with the first meal data.

These and other examples are described further below with reference to figures.

### BRIEF DESCRIPTION OF THE DRAWINGS

The included drawings are for illustrative purposes and serve only to provide examples of possible structures and operations for the disclosed inventive systems, apparatus, methods, and computer program products for operation of robotic food production centers. These drawings in no way limit any changes in form and detail that may be made by one skilled in the art without departing from the spirit and scope of the disclosed implementations.

FIG. 1 illustrates a block diagram of an example system, in accordance with certain embodiments.

FIG. 2 illustrates a system, in accordance with certain embodiments.

FIG. 3 illustrates a block diagram of an example meal preparation system, in accordance with certain embodiments.

FIG. 4 is a flow chart of a technique for determining a meal and outputting meal preparation data, in accordance with certain embodiments.

FIG. 5 is a flow chart of a further technique for determining a meal and outputting meal preparation data, in accordance with certain embodiments.

FIG. 6 illustrates a block diagram representation of an example meal data output, in accordance with certain embodiments.

FIG. 7 illustrates a block diagram of another example system, in accordance with certain embodiments.

FIG. 8 illustrates a flowchart illustrating a technique for processing of data for determination of instructions for operation of autonomous meal preparation robots, in accordance with certain embodiments.

FIG. 9 illustrates a block diagram of an example data input for automatically created system meal generation, in accordance with certain embodiments.

FIGS. 10A-D illustrate example GUIs for meal generation, in accordance with certain embodiments.

FIG. 11 illustrates a block diagram of an example computing system, in accordance with certain embodiments.

### DETAILED DESCRIPTION

Described herein are autonomous meal preparation robots and techniques for operating autonomous meal preparation robots. Specifically, operation of autonomous meal preparation robots described herein allows for adaptive meal generation control programs that tailors meals prepared by the autonomous meal preparation robots to an individual ordering user. Furthermore, generation of the meals may include generation and communication of data of a proper shape appropriate for the configuration of the autonomous meal preparation robot.

Thus, the techniques described herein combines ingredient-specific nutritional and culinary attributes with a user's health and fitness data to allow for generation of meal preparation control programs for autonomous meal preparation robots that provide customized ingredient portion sizes and personalized nutritional outcomes that are tailored to the user's health and fitness goals, dietary preferences, and culinary tastes. Such personalized meal preparation control programs are provided to autonomous meal preparation robots described herein in a manner that can be utilized by the specific configuration of the specific autonomous meal preparation robot. The autonomous meal preparation robots are configured to receive such personalized meal preparation control programs and produce meals according to such programs.

Such personal meal preparation control programs may be in a data shape that can be consumed by the specific autonomous meal preparation robots. Various configurations and systems of autonomous meal preparation robots may be operated with data of various different shapes. The system and techniques described herein may provide meal preparation data of a data shape that can be utilized by the target autonomous meal preparation robot.

The autonomous meal preparation robots described herein are configured to dispense ingredients in any combination and at any portion size. The techniques for utilizing such autonomous meal preparation robots described herein are configured to eliminate static capability limitations that are present in typical online ordering platforms. For example, unlike typical techniques that only provide for fixed recipes with static portion sizes, the techniques described herein provide for adaptive ingredient portion size modification, ingredient combination modification, and ingredient substitutions by autonomous meal preparation robots and/or the controllers of the autonomous meal preparation robots to, for example, tailor to individual health and fitness goals. The techniques described herein may utilize real-time data from health and fitness applications, wearable devices, and/or other user devices to provide for improved and healthier (e.g., based on personalized nutrition and wellness) autonomous meal assembly by autonomous meal preparation robots.

In various embodiments, the systems and techniques described herein may provide for autonomous meal preparation robots to fulfill personalized nutrition needs, allowing users to achieve specific health and fitness outcomes through meal preparation control programs tailored to their unique profiles, health data, goals, and other aspects. The systems and techniques described herein provide a platform that dynamically selects, recommends, and portions ingredients for a user based on such profiles, to simplify a meal ordering process while ensuring optimal health outcomes. Furthermore, the systems and techniques described herein are configured to integrate third party data sources, such as a meal tracker, fitness tracker, scheduling, and goal setting applications, by receiving such data and utilizing such data to determine real-time meal recommendations and adjustments based on the user's current activity and biometric data. Accordingly, the preparation of meals by autonomous meal preparation robots may be adjusted on an individual basis according to data received from third party sources, such as third party tracking data. Culinary quality may be maintained through ingredient-specific culinary rules to ensure that recommendations and modifications maintain high taste standards.

### Autonomous Meal Preparation System

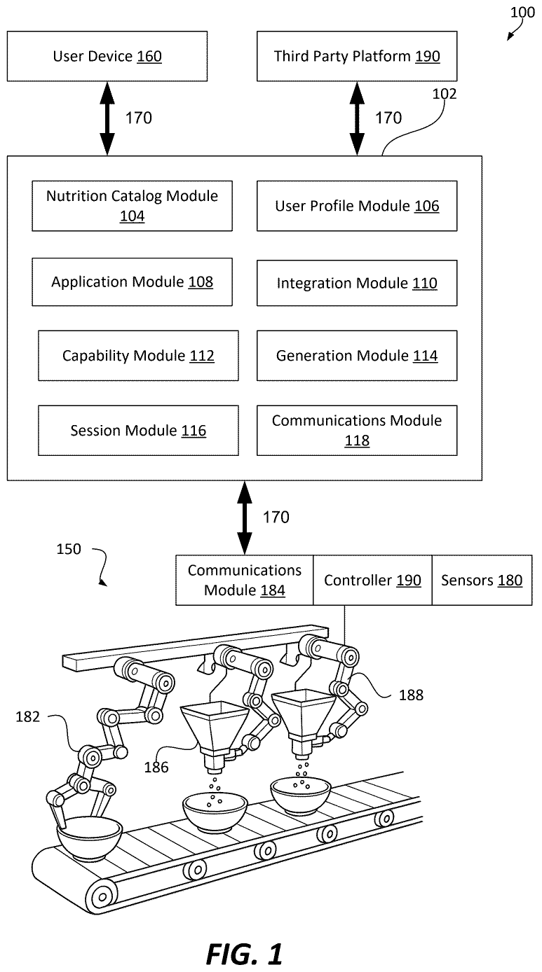

FIG. 1 illustrates a block diagram of an example system, in accordance with certain embodiments. FIG. 1 illustrates autonomous meal preparation system 100, which includes autonomous meal preparation platform 102, autonomous meal preparation robot 150, user device 160, and third party platform 190.

Platform 102 may be a platform for controlling operation of autonomous meal preparation robot 150. Platform 102 may be communicatively coupled to user device 160 and autonomous meal preparation robot 150 via communications channel 170. Such communications may be communicated and/or received via communications module 118. In various embodiments, communications channel 170 may be any wired and/or wireless data connection, such as, for example, a wired Ethernet connection or a wireless data connection such as WiFi, 3G, 4G, 5G, or another such connection that allows for data to be transmitted. In various embodiments, the various portions of autonomous meal preparation platform 102 described herein may utilize one, some, or all such data connections to communicate and/or receive the various data described herein, including portions not illustrated to be communicatively coupled via communications channel 170. For example, the different modules of platform 102 may also be communicatively coupled via communications channel 170 (e.g., for embodiments where platform 102 is implemented as a plurality of different computing devices) in addition to user device 160 and autonomous meal preparation robot 150.

User device 160 may be an electronic device utilized by a user (e.g., account holder) of platform 102. In various embodiments user device 160 may include one or more of a smartphone, a computer, a laptop, a wearable device, a kiosk, and/or another such device that provides the capability for a user to provide inputs and/or other receive data that may be communicated to platform 102. In various embodiments, user device 160 may include one or more applications (e.g., software) that is communicatively coupled to platform 102. Such applications may be an application for a user to provide meal orders to platform 102 for preparation by autonomous meal preparation robot, as well as other applications such as health and wellness applications that may, for example, communicate data directed to the user's preferences and/or biometric data. User device 160 may include a graphical user interface (GUI), speakers, and/or other outputs to provide data output to a user. User device 160 may also include one or more input devices, such as microphones, keyboards, touchscreens, and/or other such input devices to receive inputs from the user.

Autonomous meal preparation robot 150 may be configured to receive data from platform 102. Autonomous meal preparation robot 150 may be configured to prepare meals based on data generated by platform 102. In various embodiments, such data may specify the ingredients, portions, and preparation steps (e.g., chopping, cooking, baking, and/or other such steps) needed for autonomous meal preparation robot 150 to prepare a meal for the user of user device 160.

Autonomous meal preparation robot 150 may be, in various embodiments, a standalone robot, a plurality of different robots that may be individually operated (e.g., a robot for ingredient preparation and another robot for cooking), an entire facility, a plurality of different facilities, and/or another such configuration of food preparation robot. In various embodiments, autonomous meal preparation robot 150 may include various drive systems, manipulation systems (e.g., end effectors), preparation systems (e.g., washing, chopping, mashing, and/or other such systems), cooking systems (e.g., water baths and/or ovens), plating systems, delivery systems (e.g., to deliver to a customer or a drop off point and/or, for multi facility systems, to deliver between facilities), and/or other such systems. For example, autonomous meal preparation robot 150 may include sensors 180, end effector 182, communications module 184, first meal module 186, second meal module 188, and controller 190. In various embodiments, autonomous meal preparation robot 150 may be configured to provide full end to end meal preparation (e.g., a full meal may be prepared with no human input) or a portion thereof.

Sensors 180 may be configured to determine operational and environmental conditions of autonomous meal preparation robot 150. For example, sensors 180 may determine which ingredients are currently available, the freshness and quality of such ingredients, whether certain meal preparation modules are operational, and/or other aspects of meal preparation. In some embodiments, sensors 180 may include cameras, weight sensors, probes, force sensors, and/or temperature sensors to provide real-time feedback to controller 190 of autonomous meal preparation robot 150 and/or platform 102.

End effector 182 may be configured to interact with a meal container during preparation. End effector 182 may be any type of end effector appropriate for automated manipulation of various items and/or aspects used in food preparation. For example, end effector 182 may include one of more robotic arms, attachments, and/or manipulation devices that are configured to receive a meal container, transport the meal container between meal modules, and hold the meal container in place during dispensing or preparation actions. Thus, end effector 182 may provide for precise handling and sequencing of preparation steps by meal module 186 and/or meal module 188.

Communications module 184 may be configured to transmit and receive data between autonomous meal preparation robot 150 and platform 102. Communications module 184 may receive configuration requests from platform 102, communicate configuration data indicating a current configuration of robot 150 back to platform 102, and receive meal data specifying preparation actions. In various embodiments, communications module 184 may utilize one or more of wired Ethernet, WiFi, or cellular communications.

Autonomous meal preparation robot 150 may include a plurality of meal modules, such as first meal module 186 and second meal module 188. Other embodiments of autonomous meal preparation robot 150 may include the more, fewer, or the same number of meal modules as that illustrated in FIG. 1. In various embodiments, autonomous meal preparation robot 150 may include additional meal preparation modules from that illustrated in FIG. 1, such as heating, mixing, or plating modules, to provide for expanded culinary functionality. In certain embodiments, autonomous meal preparation robot 150 may include a first robot that may be configured to move between various meal modules. In other embodiments, end effector 182 may be configured to move between the various meal modules.

First meal module 186 may be configured to perform a first meal preparation action. In some embodiments, first meal module 186 may be associated with a first ingredient. That is, first meal module 186 may be, for example, a first station for preparation of meals. For example, first meal module 186 may include a vessel configured to obtain, measure, and dispense the first ingredient into a meal container. The measurement may be performed by weight, volume, or another parameter as indicated by the meal data. In other embodiments, first meal module 186 may be configured to, additionally or alternatively, perform other meal preparation tasks or steps, such as heating (e.g., one or more styles of cooking), mixing, plating, and/or any other appropriate meal preparation action.

Second meal module 188 may be similar to first meal module 186. In certain embodiments, second meal module 188 may be configured to perform a second meal preparation action distinct from that of the action performed by first meal module 186. For example, second meal module 188 may obtain, measure, and dispense a second ingredient into the meal container (e.g., after the first ingredient has been dispensed). In certain embodiments, second meal module 188 may also apply a transformational step to the meal container or contents thereof, such as heating, mixing, or seasoning.

Controller 190 may include one or more processors and a non-transitory memory configured to store instructions for coordinating operation of autonomous meal preparation robot 150 (e.g., based on instructions received from platform 102). For example, controller 190 may receive configuration requests from platform 102 via communications module 184, determine the current configuration of autonomous meal preparation robot 150 based on the meal modules detected to be a part of autonomous meal preparation robot 150, and communicate such configuration data back to platform 102. Controller 190 may further receive meal data from platform 102, analyze the data to determine a meal generation sequence, and direct various elements of autonomous meal preparation robot 150 to create the meal indicated by the meal data. In certain embodiments, controller 190 may further utilize feedback from sensors 180 to dynamically adapt the meal generation sequence, thereby enabling robust and accurate meal preparation.

In various embodiments, platform 102 may include various modules, such as nutrition catalog module 104, user profile module 106, application module 108, integration module 110, capability module 112, generation module 114, session module 116, and communications module 118. In various embodiments, platform 102 may be provided by one or more server devices and/or other such devices that, for example, provide back-end services for platform 102. In various embodiments, one or more modules of platform 102 may include processors, memory, databases, communications circuitry or devices, and/or other components to allow the respective module to provide the functionality described herein.

The various modules may each be configured to perform a different aspect of the techniques described herein and may, thus, include one or more of software and/or hardware that is distinct from the other modules of platform 102. That is, in a certain embodiment, the modules may share hardware, but may have each have separate software. In another embodiments, the modules may include one or more hardware (e.g., processor or non-transitory memory) that is physically distinct from that utilized by the other modules. In a further embodiment, the modules may be prepared by different portions of one overarching computer program.

Nutrition catalog module 104 may be configured to store and provide data directed to attributes of various ingredients utilized by autonomous meal preparation robot 150. Thus, nutrition catalog module 104 may include a database configured to store nutritional data (e.g. numeric macro and micronutrient content), weighted health attributes (e.g. studied health effects which may be provided as an alphanumeric and/or vector data), and weighted culinary rules (e.g. flavor pairing taxonomy which may be provided as alphanumeric and/or vector data). Such data may be stored for each ingredient available to autonomous meal preparation robot 150. Nutrition catalog module 104 may also include electronic circuitry configured to search, access, and communicate such data to other portions of platform 102.

User profile module 106 may be configured to store and provide data related to the user of user device 160. That is, user profile module 106 may include a database configured to store the user's baseline health data such as age, biological sex, weight, sport type, activity level, allergens, dietary preferences, and/or other such data.

User profile module 106 may receive such data from user device 160 and/or third party platform 190. In certain embodiments, user profile module 106 may store data directed to one or more user profiles associated with platform 102. A user may utilize a profile to, for example, communicate a meal order to platform 102. In certain such embodiments, user profile module 106 may create and/or add associated data to a user profile based on data received from user device 160 (e.g., account creation data) and/or third party platform 190 (e.g., physical tracking data communicated to platform 102 may lead to the automatic creation of a user account). Such data may be securely stored within user profile module 106. For example, such data may be encrypted, hashed, and/or stored in another secure manner. In various embodiments, such secure storage may, for example, strip or separately store identifying data from the user data or otherwise be structured to prevent identification of the associated account of the data.

User profile module 106 may also include electronic circuitry configured to search, access, and communicate such data to other portions of platform 102. In various embodiments, user profile module 106 may be configured to store such data that is associated with a plurality of different users.

Application module 108 may be configured to store and provide data related to behavior of the user of user device 160, such as order history, manual meal modifications, and/or other such behavioral data. In various embodiments, application module 108 may be configured to differentiate between different users and/or different applications. Thus, for example, data of different users may be separately stored in a secure manner. Additionally or alternatively, data of different applications may also be separately stored in a secure manner. Accordingly, a user that utilizes a plurality of different applications to order meals may have such data stored separately for security purposes or stored in a manner that allows for the data to be shared. Application module 108 may also include electronic circuitry configured to search, access, and communicate such data to other portions of platform 102.

Integration module 110 may be configured to receive data, analyze data, and provide determinations based on 3rd party user metric data (e.g., previously determined or real time metric data, such as calorie consumption, body composition metrics such as lean body mass, activity levels, and/or other such data). Integration module 110 may be configured to interface with electronic devices that provide such metric data (e.g., tracking apps on various electronic devices such as smartphones or electronic devices) to receive such metric data and store the metric data according to the user and/or associated account. As such, integration module 110 may receive data from various user devices and/or third party platforms (e.g., third party platform 190), determine the associated account of the user on platform 102 (e.g., an account with data stored within user profile module 106), and associate such data with the user. Integration module 110 may also include electronic circuitry configured to search, access, and communicate such data to other portions of platform 102.

In general, each user of platform 102 is assigned a unique identifier upon account creation. Integration module 110 may be configured to identify the respective user account within platform 102 and associate the third party data received with the respective user account of platform 102.

Third party platform 190 may include, for example, third party databases and/or other third party server devices associated with various third party applications. Such third party applications may include, for example, tracking applications such as health tracking applications. Such third party applications may be installed on one or more user devices, which may track various user attributes such as calendar schedule, exercise history, historical meal orders, and/or other such aspects. Additionally or alternatively, third party platform 190 may include server devices that are configured to receive, store, and communicate such data from various user devices.

Thus, platform 102 may utilize data from third party platform 190 to determine user health attributes (e.g., their exercise history within the last week), user culinary preferences (e.g., historical meals may be utilized to determine user taste preferences), the user's meal short term history and/or upcoming events (e.g., meals may be tailored based on events, such as exercise competitions, that the user has upcoming), and/or other aspects that allow for further tailoring of the user's meal.

In certain embodiments, platform 102 may both receive and provide data to third party platform 190. That is, for users with linked applications, platform 102 may transmit data to aid in the performance of such applications. For example, users with linked fitness applications may direct platform 102 to transmit meal details, including macronutrient and micronutrient data, to their accounts for seamless tracking and integration with other third party applications.

Capability module 112 may be configured to receive, analyze, and provide determinations as to capabilities of various autonomous meal preparation robots (e.g., autonomous meal preparation robot 150 and/or other such robots) associated with platform 102. Thus, capability module 112 may include a database that is structured to store data directed to the capabilities of various autonomous meal preparation robots. In certain embodiments, such data may, for example, be provided by the manufacturers of the autonomous meal preparation robots, determined empirically (e.g., via testing), received from autonomous meal preparation robot 150 itself, and/or from information received from third party sources (e.g., open sourced information). Capability module 112 may also include electronic circuitry configured to search, access, and communicate such data to other portions of platform 102, such as to generation module 114. Capability module 112 may include stored data and/or data received in real time or near real time (e.g., during the processing of a customer order).

Capability module 112 may include data directed to the configuration of autonomous meal preparation robot 150. Capability module 112 may include data directed to the configuration of autonomous meal preparation robot 150. Autonomous meal preparation robot 150 may be a robotic assembly that includes one or a plurality of submodules. Each of the submodules may be configured to perform one or more tasks for preparation of a meal (e.g., cutting, grilling, baking, etc.). Autonomous meal preparation robot 150 may vary in configuration depending on the modules that form the robot and/or that are operational. That is, autonomous meal preparation robot 150 may be a modular robot where fewer or additional modules may be coupled together to form a robotic assembly.

Capability module 112 may also include data directed to the data shape required by autonomous meal preparation robot 150. For example, different models of autonomous meal preparation robot 150 (e.g., from different manufacturers or different lines from the same manufacturer) may require data of different data shapes to correctly operate. Updates to autonomous meal preparation robot 150 may also require different data shapes. Capability module 112 may store or receive data indicating the required data shape to operate autonomous meal preparation robot 150. Outputs from platform 102 to autonomous meal preparation robot 150 may be in accordance with the required data shape to operate the autonomous meal preparation robot 150.

In certain embodiments, autonomous meal preparation robot 150 may include sensors 180. Sensors 180 may provide data directed to the current capabilities of autonomous meal preparation robot 150. For example, sensors 180 may be configured to determine which ingredients autonomous meal preparation robot 150 has available for preparation, which preparation and cooking capabilities it currently has operational (e.g., an oven may be faulty and sensors 180 may determine such conditions), which ingredients are fresh (e.g., based on visual analysis by a camera and/or based on a time stamp of when each ingredient is loaded), and/or other such aspects. Such data from sensors 180 may be communicated to platform 102 and received and/or stored by capability module 112. Such data may inform the creation and/or adjustment of meal control programs by generation module 114.

Generation module 114 may be configured to receive meal generation requests from user device 160 and, based on data received by platform 102, generate meal data. Such meal data may be, in a certain embodiment, meal control programs for autonomous meal preparation robot 150 to prepare meals (whether pre-determined or partially or fully generated by generation module 114) in response to the meal generation request from user device 160. In other embodiments, such meal data may include meal tickets provided to a meal preparation center. For example, such meal data may be provided to a third party meal preparation service, which may utilize the meal ticket to then prepare a meal generated by generation module 114.

Thus, generation module 114 may incorporate data received from user device 160 (e.g., data indicating user orders) as well as data from other databases of platform 102, such as nutrition catalog module 104, user profile module 106, application module 108, integration module 110, and/or capability module 112. Based on such data, generation module 114 may determine meal control programs for autonomous meal preparation robot 150, according to the techniques described herein.

In various embodiments, platform 102 may utilize user profile data (e.g., from a database of user profile module 106), user fitness tracking data (e.g., communicated by user device 160), historical meal consumption data, a determination of baseline user statistics (e.g., based on the height, weight, gender, and/or other characteristics of the user) to generate tailored meals for a user.

User profile data may be data unique to the user, such as medical history, test results, a determination of baseline caloric consumption of the user (e.g., based on a determined relationship between user weight tracking and caloric intake), and/or other such user specific characteristics. User fitness tracking data may include biometric measurements, activity tracking data, and/or other performance metrics (e.g., sleep tracking data) received from user device 160 and/or third party platform 190. Meal consumption data may include prior meal orders and the nutritional values of those meals as well as other user input or automatically determined nutritional intake history.

In various embodiments, such tailored meal generation may result in inputs that vary greatly between user sessions, based on the latest data from user device 160 of the user's. Accordingly, session module 116 may be configured to provide a unique baseline session payload for generation module 114, for each user meal request session. That is, after a meal generation request is received from user device 160, session module 116 may receive user data from user device 160, template data from various modules and/or databases of platform 102, and/or configuration data from autonomous meal preparation robot 150. Session module 116 may then analyze such data to determine a session-specific payload for a given meal generation request and provide such a payload to generation module 114.

Generation of a single session payload provides a unified set of parameters for a specific meal request. For example, between various meal generation requests, user fitness tracking data may differ, a user's baseline data (e.g., weight) may change, different ingredients and/or modules may be available to the meal preparation destination (e.g., autonomous meal preparation robot 150 and/or another meal preparer such as a third party meal preparer), and/or other changes may change. The myriad of possible changes would be impracticable and computationally expensive for generation module 114 to accommodate as generation module 114 may need to be configured to accommodate huge variations in data input shape. As there is already almost an infinite amount of different meals that are possible to generate, the resulting meals generated by generation module 114 may be unpredictable in terms of processing need, quality, and/or makeup.

Instead, session module 116 is configured to receive the various inputs and generate a session payload of the data shape appropriate for use by generation module 114. Session module 116 may, thus, combine various data such as user template data (e.g., nutritional goals, dietary restrictions, or preferences), external data (e.g., fitness or biometric data), and configuration data (e.g., indicating which modules of autonomous meal preparation robot 150 are currently operational) into a discrete payload.

For example, session module 116 may be configured to access capability module 112 to determine the appropriate data shape for autonomous meal preparation robot 150. Thus, for example, session module 116 may request that capability module 112 provide the data shape appropriate for autonomous meal preparation robot 150 and determine control program data for autonomous meal preparation robot 150 in accordance with the required data shape.

Based on the relevant inputs, session module 116 may receive the appropriate data and analyze such data to determine nutritional targets, preferred ingredient combinations, and portion sizes for a specific meal generation request. For example, if user fitness data indicates increased activity levels, session module 116 may generate a payload for generation module 114 that adjusts macronutrient ratios to increase carbohydrate or protein portions.

Thus, generation module 114 may be configured to only ingest payloads of a specific data shape and generate meals based only on inputs of that specific data shape. Such a configuration reduces the computational requirements of meal generation through simplification of the possible inputs that generation module 114 would need to accommodate, reducing meal generation processing.

By consolidating these data sources into one session payload, session module 116 may ensure that each meal request is processed in isolation, reducing the risk of errors caused by overlapping requests, data conflicts, or stale information. Furthermore, session module 116 may also be configured to receive inputs that are relevant (e.g., of a relevant time period) and, furthermore, may generate outputs of the appropriate data shape even in situations where one or certain data inputs are missing (e.g., the module configuration of autonomous meal preparation robot 150).

In various embodiments, generation module 114 may be configured to utilize pre-existing meal control programs, may modify pre-existing meal control programs, utilize user specified meal control programs, modify user specified meal control programs, and/or generate a complete new dish or meal as needed. Such techniques are further described herein. Thus, generation module 114 may include a database that stores data directed to preparation of pre-existing meal control programs and/or may be configured to receive data from user device 160 directed to defining a meal control program, according to the techniques described herein.

In certain embodiments, generation module 114 may be configured to provide for generation of menus of third parties, such as vendors, restaurants, and/or other such third parties. For example, generation module 114 may receive inventory data from third party platform 190, which may be a platform associated with a vendor or restaurant. Third party platform 190, or platform 102, may store and/or track inventory data associated with one or more physical locations of the third party. Such inventory data may provide an indication of the ingredients that are available for meal creation.

Generation module 114 may be configured to receive inventory data, sales data, nutrition data, and/or other such data from third party platform 190 and/or portions of platform 102. Based on such data, generation module 114 may be configured to create one or more menus for the third party. Such menu generation may be according to the meal generation techniques described herein. In certain embodiments, such menu generation may be according to an “average” user or a plurality of different user archetypes of third-party platform 190, and/or utilizing another such technique to cause one or a plurality of menu items to be determined.

Communications module 118 may be configured to communicate data between platform 102, user device 160, third party platform 190, and/or autonomous meal preparation robot 150. In various embodiments, communications module 118 may be a communications module configured to communicate via any short (e.g., within line of sight) or long-ranged communications protocol, such as Bluetooth, Ethernet, WiFi, cellular networks, and/or other communications protocols.

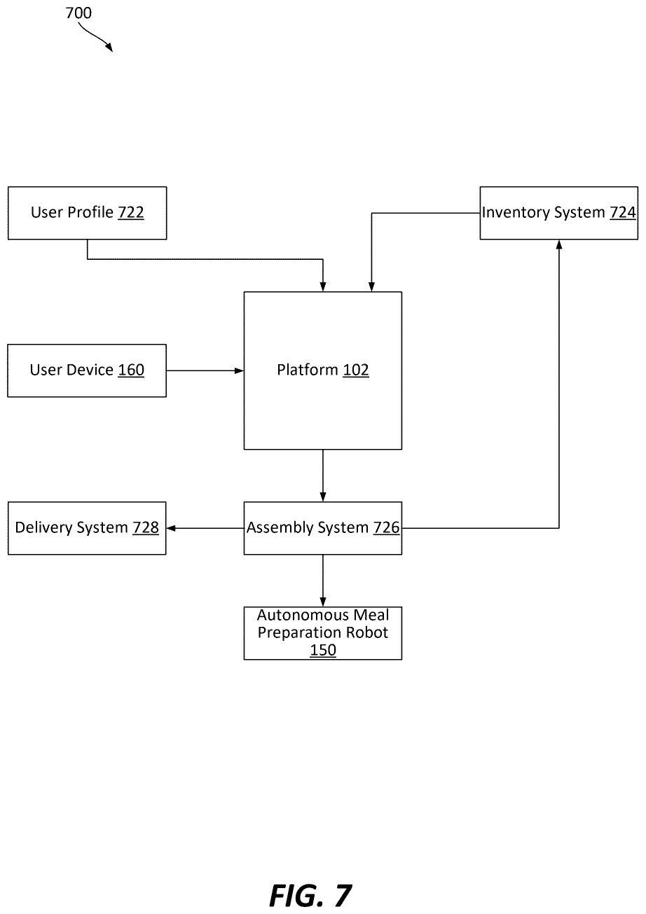

FIG. 7 illustrates a block diagram of another example system, in accordance with certain embodiments. FIG. 7 illustrates system 700 that includes platform 102, nutrition database 104, user device 160, autonomous meal preparation robot 150, user profile 722, inventory system 724, assembly system 726, and delivery system 728.

Platform 102, user device 160, and autonomous meal preparation robot 150 may be similar to that described for autonomous meal preparation system 100. In various embodiments, platform 102 may include some or all of the components described in FIG. 1. Thus, for example, platform 102 may include generation module 114 for generation of user meals and nutrition catalog module 104 for determination of the nutritional value of meals and tracking of user nutritional intake, as well as other modules described in FIG. 1.

User profile 722 may be one or more databases configured to store data associated with the user of user device 160. For example, user profile 722 may include data directed to user fitness, user body data (e.g., medical data such as bloodwork data, ancestry data such as DNA data, and/or other such data), user vitals (e.g., blood pressure, height, weight, gender, and/or other such data), manually input user data, and/or other such data that may inform creation of the meal for health, fitness, taste, and/or other reasons.

Inventory system 724 may include a database for tracking inventory (e.g., of ingredients, utensils, and/or other such inventory) at one or more locations with autonomous meal preparation robots. Inventory system 724 may provide data related to such inventory levels to platform 102 as well as update the inventory based on meal preparation performed by assembly system 726.

Utilizing data from inventory system 724, platform 102 may be configured to generate menus for assembly system 726. Generation of menus may utilize data from inventory system 724 as well as data one or a plurality of user profile 722, and/or other systems. Thus, platform 102 may receive inventory data, sales data, nutrition data, and/or other such data from inventory system 724, user profile 722, user device 160, and/or other such devices. Based on such data, platform 102 may be configured to create one or more menus (e.g., in accordance with data from inventory system 724).

The system and techniques described herein may include techniques for generation of a plurality of different meals. Platform 102 may generate one or a plurality of different meals according to such techniques for the menu. Thus, for example, the third party may request generation of menus through one or more user meal generation requests. As such, both a user requesting meals as well as a third party such as a restaurant may provide meal generation requests and meals may be generate for user meals as well as for creation of menus for the third parties. In certain embodiments, the third party may accept or reject the created menu on an entire or ad hoc basis and platform 102 may generate and/or regenerate menus based on such feedback.

Assembly system 726 may include a system for operation of meal preparation and delivery systems (e.g., autonomous robots for performing such roles). Thus, assembly system 726 may be one or more computer devices (e.g., server devices) configured to provide coordination of operation of autonomous meal preparation robot 150 and/or delivery system 728, as well as provide updates to inventory system 724 (e.g., indicating changes in inventory from meal preparation order).

Delivery system 728 may include one or more of a pickup system (e.g., where the user may pick up their meal order from a location) or delivery system (e.g., where a meal order is delivered to the user). Such pickup or delivery systems may be automated and may be operated by, for example, autonomous robotic units that provide delivery and/or carry completed orders to a specified location.

User device 160 may provide for a request for meal generation to platform 102. Thus, user device 160 may provide a request for meal generation for from a user to platform 102. Platform 102 may include generation module 114 configured to generate a meal based on the user's requirements (e.g., based on user profile 722 as well as other data). In various embodiments, generation module 114 may be configured to generate a meal according to only user profile 722 or may be configured to generate a meal based on user profile 722 and/or other data, such as user selected parameters or sensor data from user device 160 or other platforms.

Based on user profile 722, user selected parameters, and/or other such data, generation module 114 may generate a meal for the user. In various embodiments, platform 102 may provide that meal for review by the user. The user may then accept the meal or provide inputs into a GUI of user device 160 to customize the meal. The resulting meal may be provided to assembly system 726 so that it can be produced by autonomous meal preparation robot 150 and delivered by delivery system 728 to a delivery location.

In certain embodiments, meals generated by generation module 114, the changes provided by the user, and/or other data from the generation process may be utilized by generation module 114 as part of training data to train generation module 114 for further generation of meals.

### Data Processing Examples

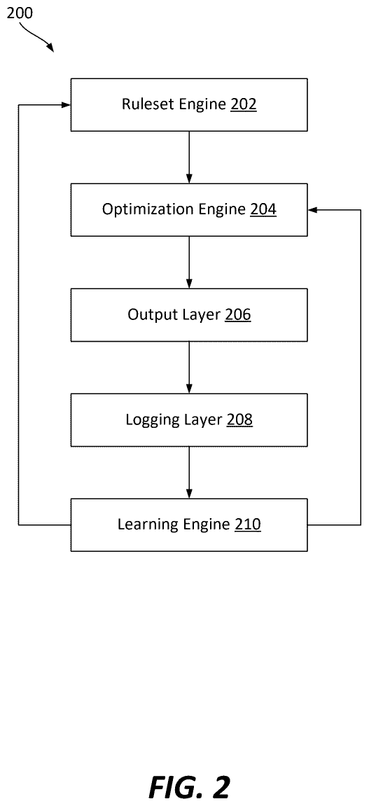

FIG. 2 illustrates a system configuration, in accordance with certain embodiments. FIG. 2 illustrates data flow 200 for operation of the systems described herein. Data flow 200 may provide data flow through ruleset engine 202, optimization engine 204, output layer 206, logging layer 208, and learning engine 210. In various embodiments, ruleset engine 202, optimization engine 204, output layer 206, logging layer 208 and/or learning engine 210 may be implemented as part one or more computing devices, such as a server device or other such computing devices.

Ruleset engine 202 may be configured to define rules for automatic generation of meals. Thus, for example, ruleset engine 202 may be configured to provide a set of rules for defining macro targets (e.g., based on the user data). Ruleset engine 202 may also be configured to define category structures, such as food categories (e.g., veggies, carbs, protein, etc.), define or determine preferred ingredients for a user, and/or other personalization aspects for a user (e.g., a rule that if a user device of a user determines that the user has been running, post-run recovery aspects may be utilized for determination of the meal to be generated).

Each ruleset of ruleset engine 202 may be structured in a modular configuration that allows for output of various data shapes based on the target data structure of the receiving device. Various rulesets may include rules that govern such shape structure. Additionally, such rules may govern the generation of meals based on nutritional targets, ingredient preferences, and/or other considerations for a specific user.

In various embodiments, generation of a meal for a user may be based on various rulesets based on the user request and preferences. Rulesets may be dynamically selected based on inputs such as user's current activity type (e.g., strength or endurance training, intensity level, timing such as pre or post activity meal, meal size, as well as data synchronization from fitness apps and wearable devices), culinary preferences, forward looking schedule, and/or other such aspects. Platform 102 provides for selection of one or a plurality of rulesets based on user goals, preferences, or context (e.g., post-workout, recovery, weight loss). Each ruleset may define meal structure, exclusions, intelligent pairings, and/or other such aspects of meal generation. Accordingly, each user may be associated with one or a plurality of pre-defined rulesets based on their user profile for generation of meals.

Each ingredient may include one or a plurality of data tags directed to nutritional content, ingredient category, ingredient tastes, food allergies, and/or other such tags. In certain embodiments, various rulesets may provide definition or guidance as to how many ingredients of each category to include (e.g., in a meal generated for a user), which data tags to prioritize, and how to enforce culinary or functional pairings as well as which ingredients to avoid.

In certain embodiments, ruleset may be stored in any appropriate format, such as encoded as modular JSON objects and stored in a database configuration layer, enabling dynamic switching across user profiles, fitness contexts, and kitchen formats.

Optimization engine 204 may be an engine for determining ingredients to be incorporated into a generated meal. For example, optimization engine 204 may utilize mixed-integer programming to select ingredients and portion sizes that meet the user's nutritional targets and culinary profile (e.g., in accordance with data stored within various databases of the platform or from third party sources). Thus, optimization engine 204 may be configured to generate a meal in accordance with the techniques described herein.

Optimization engine 204 may provide for selection of ingredients and portions that meet a user's preferences (e.g., stored within a user database). Such preferences may be stored as data that defines macro targets, category structure, tag preferences, and/or other such preferences and/or goals of the user. Optimization engine 204 may optimize a meal for the user based on such preferences.

Thus, for example, users may input user-specific macro targets (e.g., calorie goals, nutritional goals, and/or other such targets), may provide data derived from biometrics, recent activity, and time of day, whether entered manually or automatically provided by various devices, may filtered ingredient pools (e.g., define ingredient preferences), and/or may indicate dietary exclusions. Additionally, non-user-specific data may also be utilized by optimization engine 204. Such data may include inventory availability, kitchen routing feasibility, currently configuration of autonomous meal preparation robot 150, planned maintenance, and/or other such aspects.

Optimization engine 204 may utilize various rulesets described herein. For example, such rulesets may define required ingredient categories and exclusions of a user, as well as preferred ingredients as well as pairing constraints. Such ingredients and ingredient characteristics may be indicated via various tags within data for each ingredient. Users may provide input and preferences and optimization engine 204 may accordingly modify tag weights, ingredient preferences, novelty bias, and diversity penalties per user or session based on such inputs or based on stored data.

Optimization engine 204 may be configured for various goals. For example, a user may indicate that cost is important and, thus, optimization engine 204 may optimize for meal cost. Certain users may also indicate or show a preference for certain tastes (e.g., ingredients with “umami” tags) and, thus, optimization engine 204 may accordingly optimize the ruleset associated with the user to favor ingredient combinations with tags synergistic with “umami” (e.g., “umami” and “acidic”) and penalize tags that clash with “umami”. Accordingly, optimization engine 204 may create or modify a ruleset to reinforce learned user behavior. Thus, optimization engine 204 may create or modify a ruleset to boost ingredients commonly added or accepted by the user, penalize those skipped, swapped, or removed by the user through adjustment of an ingredient ID's score in optimization. Optimization engine 204 may also promote freshness and diversity to a user's generated meal by reducing scores for recently used ingredients and increasing underused tags to prevent repetition and support learning.

Output layer 206 may receive the generated meal and provide data in a data shape appropriate for use by autonomous meal preparation robot 150. As described herein, various autonomous meal preparation robot 150 or configurations thereof may require data in specific data shapes. Output layer 206 may receive data from the autonomous meal preparation robot 150 for fulfillment of the meal and determine the appropriate data shape. Output layer 206 may then provide data in the appropriate shape so that autonomous meal preparation robot 150 may create the generated meal. Such appropriate data shape may include data formatted into specific structured payloads, such as data configured in a specific manner for point of sale, KDS, robotics, and inventory systems. Output layer 206 may accordingly provide such data to the appropriate systems.

Logging layer 208 may be configured to capture contextual metadata (e.g., the data inputs informing generation of the system, such as user exercise history), session logic, and meal generation outcomes (e.g., user indication of satisfaction with the generated meal). Such data may be utilized for traceability and future tuning of generation module 114. Data logged within logging layer 208 may be provided to ruleset engine 202 for updating of the rules for meal generation.

Learning engine 210 may be configured to create user preference models and/or meal prediction logic based on stored historical data, data of past created meals, meal generation behavior, user feedback, and/or other such aspects. Thus, learning engine 210 may be configured for creation or training of machine learning models for meal generation. Data determined by learning engine 210 may be provided to optimization engine 204 for updating of the optimization of meals.

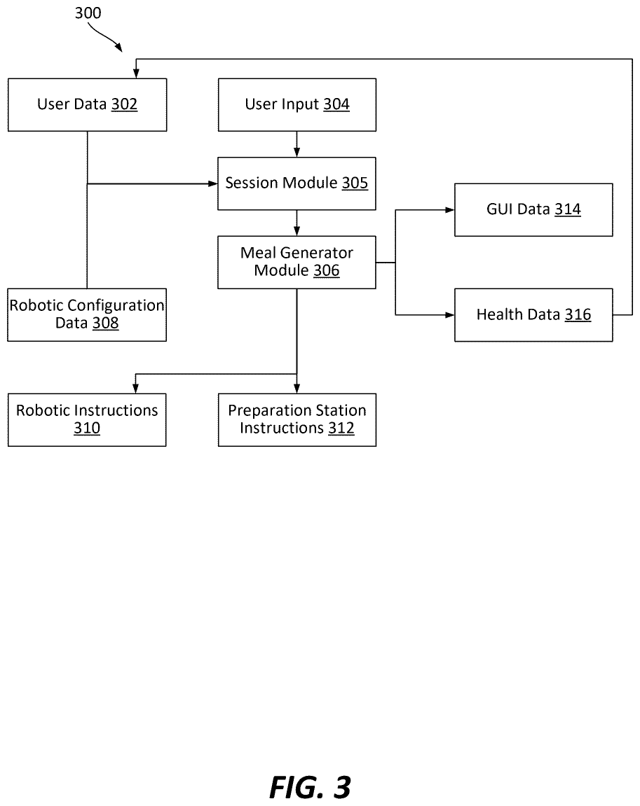

FIG. 3 illustrates a block diagram of an example meal preparation system, in accordance with certain embodiments. FIG. 3 illustrates data flow 300, which may be data for generation of meals in accordance with a user request. Such user request may be for a generated meal that is a modification of an existing meal or a meal that is fully generated by platform 102.

Data flow 300 may illustrate data flow for creation of a meal. Thus, data flow 300 may include user data 302, user input 304, session module 305, meal generator 306, robotic configuration data 308, robotic instructions 310, preparation station instructions 312, GUI data 314, and health data 316.

User data 302 may include historical user data and user preferences stored within various databases described herein. For example, user data 302 may include prior meal selections, nutritional intake history, baseline health attributes, and data received from third party platforms. User input 304 may include user input into a GUI of a user device. User input 304 may, thus, include input indicating that the user is requesting a meal generated by platform 102 as well inputs indicating various preferences and/or conditions for the meal by the user, such as a request for a specific meal, modifications to an existing meal, or dietary exclusions for a particular session.

Session module 305 may be configured to determine session-specific payloads for controlling an individual session of meal generator 306 in response to an individual meal generation request. In various embodiments, session module 305 may operate as an intermediary between user data 302 and user input 304 and meal generator module 306. That is, session module 305 may receive data from user data 302 and user input 304 and generate a payload for output to meal generator 306 to cause and/or control operation of meal generator module 306 for generating a meal. In certain embodiments, meal generator module 306 may be generation module 114 or a portion thereof.

Session module 305 may be configured to receive both user data 302 and user input 304 and to reconcile such inputs into a unified session payload to inform operation of meal generator 306. For example, session module 305 may overlay stored user preferences with current user instructions and contextual data (e.g., fitness activity or biometric readings) to produce a payload of a standardized data shape for consumption by meal generator 306. In various embodiments, the payload generated by session module 305 may be of a data shape that specifies, for example, nutritional targets, ingredient preferences, portion sizes, and/or other meal generation parameters applicable to a current meal generation request.

In various embodiments, the payload generated by session module 305 may also incorporate robotic configuration data 308 as an input, indicating the current operational state of autonomous meal preparation robot 150. Robotic configuration data 308 may be data indicating the configuration of autonomous meal preparation robot 150. That is, in various embodiments, autonomous meal preparation robot 150 may include a plurality of modules and one, some, or all such modules may be present at a certain point in time. Robotic configuration data 308 may indicate that configuration as well as indicate any changes in data shape based on the configuration. Furthermore, autonomous meal preparation robot 150 may be a specific make and model of meal preparation robot and robotic configuration data 308 may indicate the make and model or the data shape required for the make and model.

Accordingly, session module 305 ensures that the payload transmitted to meal generator module 306 reflects both user-driven requirements and system capabilities, enabling meal generator module 306 to generate meals that are achievable by the target robotic system.

In certain embodiments, positioning session module 305 as an intermediary that obtains data and provides a payload to meal generator 306 for controlling meal generation provides several advantages. For example, session module 305 ensures data consistency by consolidating heterogeneous sources of data, such as historical preferences, biometric updates, and real-time user selections, into a standardized payload. Additionally, session module 305 allows for different requests to be isolated. That is, each meal generation session is processed independently, preventing data conflicts between concurrent or sequential user requests. For example, session module 305 ensures that data from an appropriate time period is utilized in generation of the payload. Furthermore, session module 305 reduces the computational complexity for meal generator module 306 by normalizing diverse data inputs into a single data shape, allowing meal generator module 306 to focus exclusively on generation of meal data rather than pre-processing user or system inputs. Session module 305 may also improve adaptability, as adjustment of session module 305 may allow for adjustment of payloads that are generated by session module 305 (e.g., how user data 302 or user input 304 may influence the resulting payload), without requiring architectural changes or updates to downstream meal generation modules, such as meal generator 306. Accordingly, meal generation and input creation systems of data flow 300 may be separated, providing for greater control over each portion of the process.

Such a creation may also provide for flexibility as, for example, one or the other of session module 305 and/or meal generator 306 may be controlled via traditional programming, artificial intelligence, and/or machine learning techniques. (For example, session module 305 may be operated via traditional input output programming while meal generator 306 may be operated via artificial intelligence or neural network based processes), or vice versa. Utilization of session module 305 may also enhance traceability as each session payload may be uniquely logged and associated with a specific meal request, enabling auditability, feedback incorporation, and iterative learning for improved meal generation.

Meal generator module 306 may be configured to generate or modify a meal based on the payload provided by session module 305. By providing a payload of a standardized data shape, session module 305 reduces the computational complexity involved in operating meal generator module 306 for meal generation, ensuring that meal generation can be performed predictably and efficiently. For example, session module 305 may remove redundant or stale data, normalize user inputs with stored preferences, and ensure compatibility with the data shape required by meal generator module 306. Meal generator module 306 may utilize such payloads generated by session module 305 to determine the structure and content of a meal in a manner suitable for subsequent preparation and fulfillment.

In certain embodiments, meal generator module 306 may receive the session payload from session module 305 and parse the payload into one or more categories of data. For example, meal generator module 306 may identify ingredient category targets, portion size requirements, and preparation constraints specified in the payload. Based on these categories, meal generator module 306 may generate meal data that specifies the ingredients, proportions thereof, manner of preparation thereof, order of preparation, and/or other aspects of a meal.

Meal generator module 306 may be further configured to receive the payload as an input and generate meal data output that includes a plurality of data objects. The data objects may be one or more separate data objects that may be consumed by downstream systems and may include, for example, robotic instructions 310, preparation station instructions 312, GUI data 314, and health data 316. By generating such structured data outputs, meal generator module 306 allows autonomous meal preparation robot 150, human preparers, or hybrid systems to accurately perform the preparation tasks associated with the meal as well as allow associated systems (e.g., nutrition tracking software) to receive such data and perform appropriate health tracking.

Thus, for example, meal generator module 306 may generate data of the appropriate shape for autonomous meal preparation robot 150. For example, robotic instructions 310 may be data provided to autonomous meal preparation robot 150 of an appropriate shape for consumption by autonomous meal preparation robot 150 to result in meal preparation. Thus, the data shape of robotic instructions 310 is configured so that autonomous meal preparation robot 150 may consume robotic instructions 310 and generate the appropriate meal. Generation may include, for example, picking, preparing, cooking, plating, and/or other such aspects of meal preparation and robotic instructions 310 may include data directed to such aspects of meal generation by autonomous meal preparation robot 150.

In certain embodiments, meal generator module 306 may also provide preparation station instructions 312. Preparation station instructions 312 may include data directed to preparation of the meal by entities other than autonomous meal preparation robot 150. For example, preparation station instructions 312 may include data directed to preparation of certain aspects of meal generation by a logistics robot (e.g., data causing delivery of certain ingredients by a robot), by a manual food preparer (e.g., preparation instructions for a worker), and/or other such data. Preparation station instructions 312 may include, for example, a meal ticket.

Meal generator module 306 may also provide GUI data 314 and health data 316. GUI data 314 may be data configured for communicate by a GUI or other user interface of user device 160. Thus, for example, GUI data 314 may include meal preparation status, health data, payment information, and/or other such data. Health data 316 may include data directed to health information of the meal that is being prepared. Thus, for example, health data 316 may include data from a nutrition catalog to provide for determination of the nutritional content of the ingredients. Such nutrition information may, in certain embodiments, be adjusted based on the preparation technique. In certain embodiments, GUI data 314 and/or health data 316 may be further communicated by the appropriate user device or server device to user data 302 for storage and/or usage in further meal determinations.

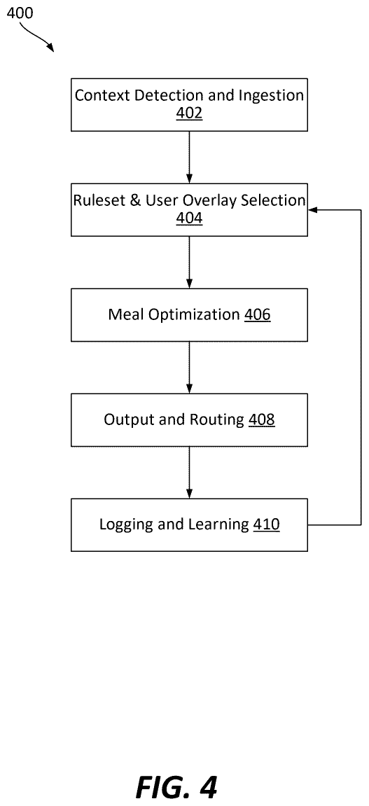

FIG. 4 is a flow chart of a technique for determining a meal and outputting meal preparation data, in accordance with certain embodiments. FIG. 4 illustrates technique 400 for automatic generation of meals and training of machine learning server devices used in the generation of such meals. Technique 400 may provide for personalization of meal generation in accordance with the history and/or preferences of a user.

In 402, user and system context may be detected and ingested. That is, various user data, such as data directed to a user's profile, preferences, and/or activities (e.g., activity data from various sensors of user device 160) may be ingested by a module of platform 102 (e.g., generation module 114 and/or session module 116). Furthermore, ingredient data, inventory data, health data, and/or other such data may also be ingested. Such data may inform the appropriate ingredients used during meal generation. Such data may also provide for determination of fulfillment and/or other operational constraints of autonomous meal preparation system 100.

In 404, base ruleset as well as any rulesets associated with the user may be selected and overlaid to create a personalized profile for meal generation for the user. Utilization of both base and user specific rulesets allow for a declarative structure to be maintained in data processing for meal generation while allowing dynamic adaptation to individual preferences and context.

Contextual data may also be overlaid in 404. Such contextual data may include user exercise data, user schedule data, and/or other such data. In certain embodiments, 404 may also receive data from autonomous meal preparation robot 150 and inventory data and exclude unavailable inventory or preparation techniques.

Base rulesets, user specific rulesets, and contextual data may then be merged into a session-specific optimization configuration file (e.g., in response to a user request for meal generation) that personalizes behavior, scoring, and ingredient selection within an available ingredient pool.

Based on the overlay of 404, meal generation and optimization may be performed in 406. In 406, base tag weights of ingredients may be adjusted based on user priorities or preferences, substitution logic may be determined for preferred ingredients (e.g., chicken for beef), modifiers to novelty bias, cost sensitivity, or diversity scoring may be applied, and/or other such modifications to ingredient data may be applied based on the overlaid rulesets of 404. Platform 102 may thus create a modified ingredient dataset of 406 (e.g., adjusting certain ingredient weights) based on the user specific overlay of 404.

A meal, and the appropriate data for creating the meal, may then accordingly be generated. Such data may include ingredient data, preparation data, portion data, and/or other such data appropriate for preparation of a meal by autonomous meal preparation robot 150.

In certain embodiments, a generated meal may be provided to a user device for acceptance (e.g., via display on a GUI of the user device). The user may thus accept the generated meal or may opt to regenerate a meal. Meal regeneration may be governed by soft constraints, penalizing redundant outputs and enforcing tag diversity. This ensures that regenerations remain novel, contextually relevant, and increasingly accurate over time.

In 408, the meal data generated may be output and routed to the appropriate destination. Thus, in 408, data associated with the generated meal may be created according to the appropriate data shape (e.g., data shape appropriate for autonomous meal preparation robot 150 to receive and prepare the deal).

For example, such data may include ingredient data with routing metadata (e.g., indicating which module of autonomous meal preparation robot 150 should receive the data), nutritional macros for labeling and receipts, data directed to preparation instructions and sequencing, scoring logs, personalization tags, and display metadata, and segmented payloads for point of sale (POS), KDS, inventory, and robotics systems.

In certain embodiments, meal data may include category data for each ingredient (e.g., protein, base, garnish, or another such category). When such data is processed by a receiving assembly system 726 and/or autonomous meal preparation robot 150, the ingredient categories are then dynamically mapped to actual stations based on the current configuration of the assembly system 726 and/or autonomous meal preparation robot 150. Accordingly, each ingredient may include appropriate routing metadata such as metadata directed to station type, preparation sequence order (e.g., build order across stations), preparation flags such as flags for special preparation instructions, robotic routing metadata such as bin ID and unit sizes for automated ingredient preparation. In various embodiments, routing instructions may be per ingredient, enabling split-line fulfillment and multi-modal execution.

Similarly, preparation (e.g., cutting and/or cooking) of such ingredients may also be based on such meal data. Thus, the meal data may provide for preparation instructions per ingredient or per ingredient group. The data may include data shape that provides for a combination of a plurality of ingredients into a specific group (e.g., if a plurality of ingredients are combined together during the preparation process), which may also include station type, sequence, preparation flags, and/or other such metadata.

The meal may thus be created and provided to the user. In 410, logging and learning may be performed on the creation process and/or user feedback. Thus, post-session behavior data may be utilized for learning. In certain embodiments, such learning may be system level instead of personal level, providing for separate evolution of food preparation system learning and personalization changes.

Each meal generation may thus be logged. Each meal generated may include a source ID to link back to the original generation, may include data indicating swapped ingredients, skipped tags, regeneration count (e.g., the amount of times meals were regenerated before being accepted by the user), time to final selection (which may indicate decision confidence), finalized recipe including data directed to final recipe ingredients, portions, macro totals, and fulfillment payloads. Such data may then be interpreted and updated for future generation. In various embodiments, separate system level learning and personalization changes may be performed based on the generation of one meal.

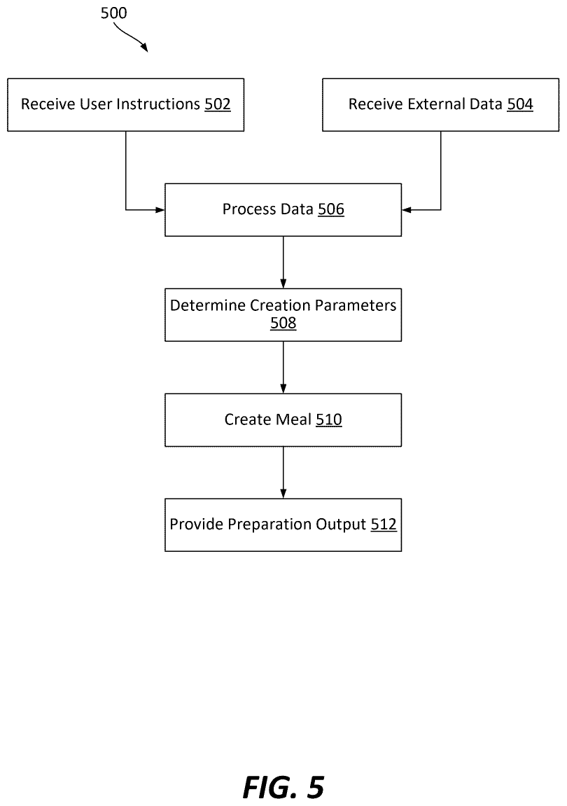

FIG. 5 is a flow chart of a further technique for determining a meal and outputting meal preparation data, in accordance with certain embodiments. FIG. 5 illustrates technique 500 for receiving data and creating a customized meal for preparation by autonomous meal preparation robot.

In 502, user instructions to create a meal may be received by platform 102. In various embodiments, such user instructions may include user inputted data (e.g., provided through an input device of a user device), previously set goals (e.g., a user may provide preset instructions to order a meal when, for example, the user's blood sugar is detected to be below a threshold amount), indicated preferences (e.g., a user may create a preset configuration where a meal is regularly ordered at a certain time of day), and/or other such inputs. The user instructions may be general instructions, such as simply an indication that the user wishes to have a meal created, or may be specific instructions such as meal preferences or even specific dishes that a user wishes to have for the meal.

In 504, external data may be received. External data may be data in addition to data received from the user device. External data may be received at any time by platform 102. Such data may include, for example, data directed to a user's profile (e.g., height, weight, biological sex, activity level, fitness tracking, and/or other such data), data directed to a user's goals (e.g., stress reduction, health improvement, strength increase, endurance increase, weight loss, and/or other such goals), current user activity level (e.g., from data provided by a third party fitness application and/or through other tracking techniques), user's schedule, and/or any other such data that may be utilized for preparing and/or modifying a meal for the user.

Examples of third party data may include, for example, nutrition planning applications, food and diet tracking applications, exercise and/or biometric tracking applications, and/or other such applications. Thus, if the user has a preset macronutrient profile for a goal of the user, such a profile and the associated goal may be onboarded onto platform 102 and populated during the ordering and meal determination process.

In certain embodiments, data from 502 and/or 504 may further include data directed to the user. Such data may include, for example, the user's recommended calorie range for meals (e.g., breakfast, lunch, dinner, and/or meals at other times of the day). The calorie range may be modified by other data received by platform 102. For example, a modifier to the calorie range may be applied based on data from connected fitness applications (e.g., indicating recent fitness activities of the user), based on the user's upcoming schedule (e.g., if the user has a competition within a week), based on the user's current physical condition (e.g., if the user is rehabbing from an injury, is experiencing health issues such as stress, or is undergoing certain cyclical conditions such as menstrual cycles), and/or based on other determined conditions.

Data from 502 and 504 may be processed in 506. Such processing may result in data that is usable for platform 102 (e.g., standardized into the appropriate formats of the databases of platform 102) and stored within the appropriate database (e.g., module) of platform 102. Furthermore, processing of such data may allow for further determination of attributes of the user.

Thus, for example, such data may allow for the determination of the user's recommended macronutrient ratio (e.g., the ratio between different nutrients that the user should intake). As activity levels may impact the macronutrient ratio, platform 102 may also determine a modifier to the macronutrient ratio based on real-time data (e.g., from connected fitness apps) to adjust based on the user's activity level. Furthermore, weighted macro rankings for each ingredient based on the user's recommended macronutrient ratio may also be determined from such data. Such macro rankings may be determined based on determined user culinary preferences, on culinary combinations (e.g., selection of one ingredient may affect the macro ranking of another ingredient), based on userbase popularity, and/or based on other aspects.

The data may also allow for determination of the user's weighted micronutrient priorities. As activity levels may impact the micronutrient priorities, platform 102 may also determine a modifier to micronutrient priorities based on real-time data (e.g., from connected fitness apps). Similarly, weighted micro rankings for each ingredient rankings based on user's weighted micronutrient priorities and/or preferences may also be determined.

Additionally, platform 102 may include data directed to the user's allergens and dietary preferences. Thus, platform 102 may filter out ingredients that the user is allergic too, de-rank or lower the rank of ingredients that the user does not prefer, and/or increase the ranking of ingredients that the user prefers, aligns with the user's health and fitness goals, and/or otherwise meets conditions or situations indicated by third party data.

In 508, meal creation parameters may be determined (e.g., by a session module) according to the techniques described herein. In various embodiments, such creation parameters may include various user and historical data described herein and may be provided as a part of a session payload. Furthermore, meal creation parameters may, additionally or alternatively, include parameters determined or provided to a meal generator module, such as parameters indicating whether the meal creation request is for one dish or a plurality of dishes. In various embodiments, such creation parameters may indicate whether the request meal is a pre-defined meal, modifications of pre-defined meals, user defined meals (with or without modification), or fully generated meals by platform 102.

Pre-defined meals may be meals that are provided in an order portal (e.g., provided on a graphical user interface of an application of the user device). For pre-defined meals, data processed in 506 may allow for modification of such pre-defined meals. Such modifications may include, for example, substitution of ingredients based on user nutrient needs, allergens, preferences, and/or autonomous meal preparation robot capabilities. For example, such modifications may include optimizing ingredient portion sizes for the user and providing applicable ingredient substitutions for the pre-defined meals. Platform 102 may perform such modifications according to culinary rules logic to ensure flavor quality. Such checking of culinary rules may be according to the user's preferences and/or as global universal rules.

Meals may include a plurality of different dishes. In certain embodiments, the order portal provided to the user may allow for the user to build their own meals. That is, data processed in 506 allows for the portal to perform initial filtering, sorting, and portioning of ingredients recommended or available to the user. The user may then select ingredients, preparation directions, cooking, plating, and/or other such aspects of the user's meals. In various embodiments, after each user selection, platform 102 re-sorts, filters, and portions each available next set of ingredients in the meal building process. Such next available ingredient may be provided according to culinary rules logic, as described herein, to ensure flavor quality. The user may then continuously select ingredients and other instructions until a full meal to the user's liking is provided.

Platform 102 may also fully generate a meal with the only user input being a command to provide a meal. In certain embodiments, the command may also indicate the type of meal, such as a post-workout meal, a recovery meal, a pre-competition meal, a regular meal, and/or other such information. Such creation may be similar to the build their own meal format, but without user input and/or with minimal user input. Platform 102 may utilize the user's stored preferences, information provided, activity data, previous meal history (e.g., in accordance with the user's preferences as to changes from a meal to meal basis), indicated goals, physical condition, and/or other such aspects to provide a fully generated meal.

Various data described herein may be utilized as meal creation parameters. For example, fitness data (e.g., from fitness trackers, fitness databases, and/or other sources) may be utilized in as parameters in determination of the meal. Though fitness data is inherently backwards looking, being only historical data, platform 102 may vectorize such data to allow for forward determination and, thus, provide for meals with nutritional content that proactively anticipates the user's nutritional needs. Accordingly, for example, vectorized fitness data may allow for the determination of fitness progress of the user and, thus, allow for a prediction of the calorie needs of a user as their fitness regime ramps up.

The creation parameters generated in 508 may be utilized in 510 to generate a meal for preparation by autonomous meal preparation robots and/or other preparation sources. Thus, platform 102 may generate the meal requested by the user in accordance with the techniques described herein and present the generated meal for review and approval by the user.

In various embodiments, meals generated in 510 may be generated via one or more meal generation vectors. Such vectors may be associated with one or a plurality of contextual dimensions that are utilized to affect generation of the meal. For example, a first vector may be associated with nutrition context and may indicate macronutrient and/or micronutrient distribution as well as calorie density. Another such vector may be associated with the activity context of a user's and may reflect the type, intensity, and timing of a user's exercise or movement. A constraint context may also be represented by a vector. Such a vector may be configured to indicate the user's macro profile and/or dietary restrictions. A vector associated with a temporal context may provide data directed to factors such as time of day, day of week, or seasonality. A vector may also be directed to a flavor context. Such flavor context may define ingredient co-occurrence rules, accepted or rejected ingredient tags, and culinary compatibility. By representing such contexts as one or a plurality of vectors, platform 102 may utilize the creation parameters determined in 508 as inputs into an optimization problem that guides the ingredient selection, portioning, and preparation determined during meal generation 510.

In certain embodiments, meal generation 510 may be performed based on the meal creation parameters determined in 508 and seeds for meal generation. Thus, for example, the meal creation parameters determined in 508 (e.g., session payload) may be utilized to select one or more meals for meal generation by the meal generator. Such seeds may then be utilized as part of the meal generation process, in accordance with the techniques described herein.

Each seed may represent a unique combination of meal constraints and result in the determination by the meal generator module of a meal that is responsive to the meal constraints. In certain embodiments, hybrid spin-off seed configurations may be automatically derived to expand available meal generation options. Such spin-off seed configurations may provide for alternative generated meal options that are based off the original seed and require lower computational power to determine as the spin-offs may require only changing of one or more parameters (e.g., substitution of one green vegetable for another of similar nutritional value) instead of complete regeneration of a meal. In certain embodiments, duplicate or near-duplicate seeds may be merged and updated to streamline the search space and the possible determinations that are required to be performed by the meal generator module.

In certain embodiments, platform 102 may maintain a plurality of high-value seeds for each user based on context of the user. For example, a Monday savory pre-run breakfast and/or a Saturday spicy post-lift dinner may be maintained for a specific user that shows a history of preferring such combinations. Such seed management allows for both personalization and variety across repeated meal requests.

In various embodiments, platform 102 may also apply machine learning techniques to adapt future meal generation based on outputs of 510. Seeds that are successfully ordered and fulfilled in a given context may be reinforced, increasing their weight and likelihood of future use. Seeds that are rejected or underutilized may be deprioritized or modified through clustering techniques. Feedback signals, including user acceptance, rejection, or modifications of meals, may dynamically reshape clusters of similar seeds. This reinforcement process allows for context-driven improvement of recommendations, such that, over time, the meal generator module may evolve to provide increasingly relevant and satisfying meal options for each user based on each user's varied contexts.

Once the meal generated in 510 has been approved for fulfillment (e.g., whether through affirmative user approval or approved through predetermined settings such as automatic approval), data for fulfillment of the meal may be created and output in 512. Such data may be of the appropriate data shape for autonomous meal preparation robot 150 selected to create the meal, as well as other portions of assembly system 726. Thus, the data may be in the format described herein for such systems. The data may be received by such systems and a meal may be accordingly created.

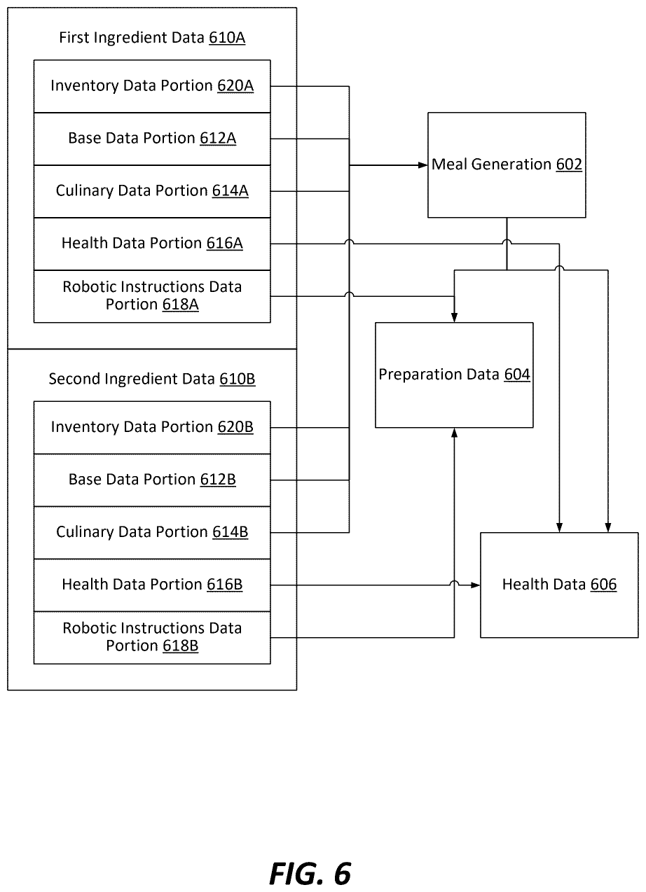

FIG. 6 illustrates a block diagram representation of an example meal data output, in accordance with certain embodiments. FIG. 6 illustrates the pre-determined data template associated with each ingredient for system 100. The example of FIG. 6 may include at least two ingredients. Each ingredient may include respective ingredient data of a pre-determined data template, which platform 102 may then utilize for preparation of the appropriate generated meal and the respective data to provide to the appropriate autonomous meal preparation robot 150. Accordingly, the first ingredient may be associated with first ingredient data 610A and the second ingredient may be associated with second ingredient data 610B.

Each of first ingredient data 610A and second ingredient data 610B may be a pre-determined first data shape and platform 102 may transform each of first ingredient data 610A and second ingredient data 610B to a second pre-determined data shape until determination that autonomous meal preparation robot 150 will prepare the meal generated by platform 102. The second pre-determined data shape may be a data shape appropriate to cause autonomous meal preparation robot 150 to create the meal.

Each ingredient data 610 may include inventory data portion 620, base data portion 612, culinary data portion 614, health data portion 616, and robotic instructions data portion 618.

Inventory data portion 620 may be data directed to inventory information associated with the respective ingredient. Inventory data portion 620 may be utilized to determine which ingredient is available for meal preparation, the freshness of the ingredient, the refill schedule of the respective ingredient, and/or other such aspect of inventory management of a specific ingredient.

Base data portion 612 may be data for database management of the respective ingredient. For example, the ingredient ID, the ingredient number, the name of the ingredient, the category of the ingredient (e.g., carbohydrate, vegetable, meat, main, garnish, and/or other such identifying data).

Culinary data portion 614 may include data for identifying the attribute(s) of the respective ingredient. Accordingly, culinary data portion 614 may include tags identifying the flavor (e.g., sweet, salty, umami), texture, preparation styles (e.g., appropriate for stir frying), and/or other such data for determination of meals, preparation, and/or combinations of ingredients thereof.

Inventory data portion 620, base data portion 612, and culinary data portion 614 may be of the appropriate data shape for platform 102 to utilize during the determination and/or creation of meals for users during meal generation 602. Such data may allow for platform 102 to determine the appropriate ingredient and preparation style in accordance with the techniques described herein.

Robotic instructions data portion 618 may be data configured for generation of instructions for autonomous meal preparation robots. In certain embodiments, robotic instructions data portion 618 may be of a basic data sheet covering the techniques that are utilized by autonomous meal preparation robots.

Upon completion of meal generation 602 (e.g., to allow for determination of the ingredients and preparation styles of the meal) and determination of the identity and configuration of the specific autonomous meal preparation robot 150, platform 102 may generate preparation data 604 of the appropriate data shape based on the generated meal and from robotic instructions data portion 618. Such data may then be provided to autonomous meal preparation robot 150. As different meal preparation robots may require different data shapes, robotic instructions data portion 618 may be flexible so that the appropriate robotic instruction data may be determined from robotic instructions data portion 618.

Health data portion 616 may health data such as nutrition, calorie, and/or other such data for health tracking of the user. Data from output of meal generation 602 and health data portion 616 may be combined and provided to the appropriate third party tracking service for nutrition tracking of the user's meals.

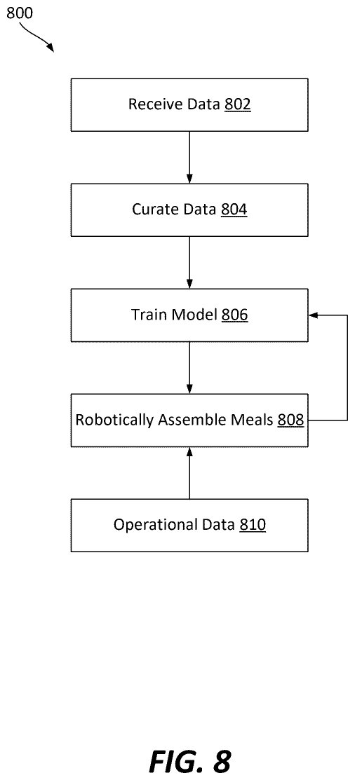

FIG. 8 illustrates a flowchart illustrating a technique for processing of data for determination of instructions for operation of autonomous meal preparation robots, in accordance with certain embodiments. FIG. 8 illustrates technique 800 for receiving and processing data.

In various embodiments, platform 102 may be configured to receive data from one or more user devices and/or third party platforms (e.g., third party tracking platforms). Thus, platform 102 may, in 802, may receive data from various other sources, such as other electronic devices or server devices. For example, platform 102 may receive numeric data from nutritional databases and taxonomical attributes from user profile catalogs (e.g., from the user devices of the users themselves and/or from third party applications such as tracking applications). Platform 102 may also receive other data, such as taste preferences (e.g., through tracking of food intake of the users, from user feedback such as surveys, and/or through other sources), variety preferences (e.g., how much a user prefers to have different types of dishes), and/or other such data.

Thus, platform 102 may receive user behavioral data from application activity logs for user associated accounts within applications. Platform 102 may also receive data from third party data feeds (e.g., from connected health and fitness application APIs for user accounts).

In 804, the data received may be curated. Curation of the data may include organizing data according to various categories, such as user account identity, calorie count, food category, data category (e.g., the type of biometric data being provided), and/or other such categories. 804 may allow for the data to be adjusted to more optimally train a machine learning model.

The model may be trained in 206 with the data curated in 804. The machine learning model may be a model utilized by an electronic device (e.g., a server device providing artificial intelligence services) for adjusting user provided or previously set meal control programs, for determining meal control programs wholesale, and/or for determining a long term meal planning strategy with preset, revised, and/or wholesale created meals. While the example of technique 800 provides for training of a machine learning model in 806, in other embodiments, the model may be provided via other techniques. That is, the model of 806 may be, for example, determined via other algorithms and/or created with other techniques. It is appreciated that, regardless of how the model is determined, the model is configured to provide adjustment of existing meal control programs and/or creation of wholesale meal control programs for an autonomous meal preparation robot in accordance with the capabilities of the autonomous meal preparation robot. Such adaptations and/or creations may be adapted based on user order history and/or biometric and/or behavioral data received by platform 102, as well as other data of platform 102.

For example, the model may include portion modifier coefficients to optimize portion sizes of individual ingredients and/or may include weighted rankings to filter and sort ingredients based on user data and goals. In certain embodiments, the model may include ranking comparisons between culinary combinations and/or culinary rules to identify optimal ingredient substitutions and/or recommendations. Such ingredient substitutions and/or recommendations may, for example, be utilized in modifications of pre-defined meals as well as at each step of full custom meals.

In certain embodiments, third party data may be utilized and normalized by the model to align with internal taxonomies. Such data may be updated within the database, allowing for dynamic adjustment of ingredient rankings and modifier coefficients. Such ingredient rankings and modifier coefficients are utilized in adjustments and/or creations of meal control programs and allow for ingredients to be combined or substituted while maintaining health attributes and taste preferences.

Thus, for example, third party data such as fitness activity data and average heart rate data may be converted into a macro nutrient modifier (e.g., 1.5 times the typical amount of carbohydrates) and a micronutrient prioritization (e.g., based on determined weights to various ingredient taxonomies for filtering and prioritization). In a certain embodiment, the third party data may provide for time-based modification (e.g. based on third party calendar data of the user, modifiers may be provided the night before a fitness competition that the user is indicated to participate within). Accordingly, for such embodiments, the modifiers may be normalized and converted into macronutrient modifiers (e.g. 2 times the typical protein amount) and micronutrient prioritization via weighting of internal ingredient taxonomies according to events indicated on the user's calendar.

The model may, thus, determine meal control programs for autonomous meal preparation robots. The model is, thus, rolled out to a platform that is associated with one or more specific autonomous meal preparation robots.

In 810, operational data may be received. Operational data may include, for example, meal requests provided by a user device, autonomous meal preparation robot capabilities, data directed to available ingredients for use by the autonomous meal preparation robot, third party data, and/or other such data.

Based on the model and operational data received, a meal control program may be adjusted or determined and provided to an autonomous meal preparation robot, which may then assemble the meal, in 808. The meal may be assembled based on meal control programs determined by platform 102 according to the techniques described herein.

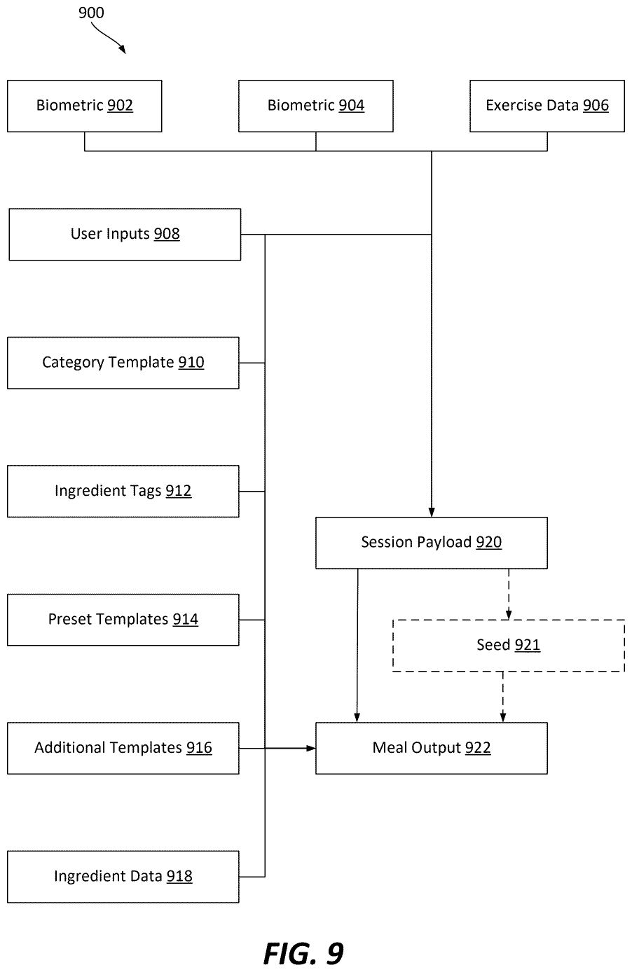

FIG. 9 illustrates a block diagram of an example data input for automatically created system meal generation, in accordance with certain embodiments. FIG. 9 illustrates block diagram 900, which is a representation of the types of data provided to a session module and/or a meal generator module, and outputs thereof, for generation of a meal.

Biometric 902 may include historical user data such as height, weight, gender, body fat percentage, Basal Metabolic Rate (BMR), and Total Daily Energy Expenditure (TDEE). Such biometric data may be utilized to establish baseline nutritional requirements for a user. For example, biometric 902 may be used to define caloric ranges and macro distribution targets that form the foundation of session payload 920. By including biometric 902, generated meals may be tailored to reflect the long-term physiological characteristics of the user.

Biometric 904 may include data provided by nutrition and fitness tracking applications. In various embodiments, biometric 904 may include real-time or near real-time metrics such as sleep quality, hydration levels, heart rate variability, and/or other such tracked data. Biometric 904 may be utilized to dynamically adjust nutritional targets within session payload 920, ensuring that meals are responsive to short-term variations in user health status.

Exercise data 906 may include activity data tracked by a device or entered manually by the user. Exercise data 906 may identify the type of activity (e.g., aerobic, anaerobic, or hybrid), the intensity of activity (e.g., from sensor-derived zones or manually provided by the user), the timing of the activity (e.g., pre-activity fueling or post-activity recovery), activity trends (e.g., average steps per day, workouts per week, or active energy expenditure), and/or other such data. Such exercise data may be incorporated into session payload 920 to provide data that modifies macronutrient ratios, portion sizes, and/or preparation methods for generated meals from the meal generator module.

User inputs 908 may include user-provided instructions for meal generation. For example, user inputs 908 may indicate a specific composition of a meal, adjustments to suggested nutrition, or the number of meals to be generated for review and selection. User inputs 908 may be integrated into session payload 920 in combination with biometric 902, biometric 904, and exercise data 906, ensuring that explicit user preferences are reflected in the generated meal as well as utilized during the meal generation process to provide meal output 922.

Session payload 920 may be generated by a session module based on inputs from biometric 902, biometric 904, exercise data 906, and user inputs 908. In certain embodiments, while not explicitly illustrated in FIG. 9, category template 910, preset templates 914, additional templates 916, and/or ingredient data 918 may also be utilized for generation of session payload 920. Session payload 920 may consolidate such data into a standardized and unified data object. Session payload 920 may serve as the primary input into the meal generator module and may be utilized to initiate meal generation. Session payload 920 may, thus be an input into the meal generator module that provides control over the meal generation process to be under explicit objectives and constraints. Thus, session payload 920 may ensure that each meal generation request is isolated, consistent, and computationally efficient.

In certain optional embodiments, the meal generator module may combine session payload 920 with seed 921 to inform generation of the meals. Seed 921 may be a meal generation seed as described herein. Seed 921 may represent a unique combination of meal constraints configured to be a starting point to allow the meal generator module to generate a meal. In certain embodiments, platform 102 may maintain (e.g., store within an appropriate database, such as a database of generation module 114) a plurality of high-value seeds for each user based on context data of the user. The appropriate seed may be selected (e.g., by the meal generator module) based on the session payload.

Category template 910 may include one or more predetermined templates stored within various databases. Category template 910 may be configured to define ingredient categories for various different ingredients utilized during meal generation. Such ingredient categories may include, for example, proteins, carbohydrates, vegetables, and dressings. Category template 910 may also define inter-category rules, such as preventing incompatible pairings or specifying preparation methods for certain categories. By applying category template 910 to session payload 920, generated meals may maintain both nutritional completeness and culinary structure.

Ingredient tags 912 may be associated with each ingredient available to platform 102. Accordingly, each ingredient available to the meal generator module may include one or more ingredient tags 912. Ingredient tags 912 may include data indicating various aspects of each ingredient, such as nutritional content, taste, texture, culinary function, and preparation style compatibility. During meal generation, ingredient tags 912 may be utilized to evaluate and score available ingredients against session payload 920, ensuring that ingredient selections align with nutritional objectives, user goals, flavor preferences, and/or dietary constraints.

Preset templates 914 may be one or more pre-determined templates configured to define default structures for generated meals. For example, a preset template may be configured to specify that a generated meal include one protein, one carbohydrate base, one vegetable, one dressing, and two toppings. In certain embodiments, multiple preset templates may be applied to session payload 920 to generate a plurality of candidate meals, allowing users to select from structurally diverse options. Preset templates 914 thus provide for balanced and varied meal structures

In certain embodiments, a plurality of preset templates 914 may be utilized during a single meal generation session. The plurality of preset templates 914 may provide control over generation of a plurality of different meals for selection. Thus, for example, a plurality of category templates may be utilized such that a meal generator module may, by default, be configured to generate a plurality of different meals. Each of the different meals may, thus, result from a different preset template 914.

For example, five different ingredient categories may be defined within the meal generator module (e.g., roots, greens, proteins, toppings, and dressing). A first meal generated by the meal generator module may be generated by a first template that specifies a first makeup of the different categories while a second meal generated by the meal generator module may be generated by a second template that specifies a second makeup of the different categories. For a plurality of meals, the present templates may have large differences to provide for variety within the generated meals.]

Additional templates 916 may provide overlays that control or refine other aspects of meal generation. Additional templates 916 may include preparation-specific templates (e.g., raw, grilled, or steamed), performance templates (e.g., meals emphasizing recovery or endurance fueling), or system-level objectives (e.g., reduce cost or promote seasonal ingredients). By incorporating additional templates 916 into session payload 920, meal generation may be adapted to contextual, operational, user, and/or business goals.

Additional templates 916 may further be configured to ensure that generated meals meet macronutrient targets of the user in a manner that may consistently interface with the meal generator module. For example, additional templates 916 may include logic that adjusts ingredient selection and portioning so that the final meal composition aligns with caloric and macronutrient goals of the user that provided user inputs 908. Thus, for example, the user may include a certain medical condition, such as diabetes, and an additional template 916 directed to diabetic users may be utilized to adjust the generation of the meal to be appropriate for diabetics.

Ingredient data 918 may include nutritional and inventory information associated with available ingredients. Ingredient data 918 may include data directed to, for example, caloric density, macro-and micronutrient content, freshness status, and/or availability of various available ingredients. In various embodiments, ingredient data 918 may be combined with ingredient tags 912 and category template 910 to allow for the meal generator module to determine the available and/or appropriate ingredient pool for meal generation.

Meal output 922 may include one or more meals generated by the meal generator module based on session payload 920 as well as user inputs 908, category template 910, ingredient tags 912, preset templates 914, additional templates 916, and/or ingredient data 918. In various embodiments, meal output 922 may be data of an appropriate data shape. Such a data shape may be matched to the requirements of the meal preparation system, which may be autonomous meal preparation robot 150, third-party meal preparation centers, or hybrid human-assisted preparation stations. For example, meal output 922 may be provided in a robotic instruction data shape consumable by autonomous meal preparation robot 150 or in a ticket-based format usable by manual or semi-automated preparation services.

Meal output 922 may include data that specifies ingredient selections, portion sizes (which may be expressed in any appropriate granularity, such as continuous grams), preparation sequencing, and routing metadata (e.g., mapping categories of ingredients to the specific stations or modules available within the preparation service). Accordingly, meal output 922 ensures interoperability between the upstream generation process and the fulfillment systems, allowing meals to be prepared regardless of whether the preparation service is robotic, manual, or hybrid.

In various embodiments, meal generator module may be, for example, an artificial intelligence solver module. The solver module may utilized one or a plurality of different solve types. In certain embodiments, solves may include full ingredient solves, tuned solves, and hybrid solves. Full ingredient solves may allow the system to freely select ingredients within dietary restrictions and in accordance with nutrient targets to generate a uniquely generated meal. Tuned solves may lock all selected ingredients of a meal and adjust only the portion sizes in order to meet the nutrient targets specified within session payload 920. Hybrid solves may lock a subset of ingredients, such as a user-selected protein and dressing, while allowing for flexibility within other categories to optimize nutritional balance and taste. Furthermore, in certain embodiments, the solver may also be utilized to support operational goals, such as prioritizing perishable inventory before spoilage, introducing seasonal or promotional ingredients, or dynamically adjusting cost through gram-based pricing.

In certain embodiments, meal output 922 may be generated according to vectors that define various aspects of the user's nutrient needs or targets and/or meal characteristics. multiple contextual dimensions for meal generation. Such vectors may include vectors directed towards nutrition context (e.g., macronutrient and micronutrient distribution as well as calorie density), activity context of the user's (e.g., activity type, intensity, and timing), constraints (e.g., target macro profile configuration or dietary restrictions), temporal contexts (e.g., time of day, day of week, seasonality, and/or other time based contexts), flavor contexts (e.g., ingredient co-occurrence patterns or accepted/rejected ingredient tags), and/or other such contexts. By structuring generation through these vectors, the baseline data provided by session payload 920 may be translated into multi-dimensional optimization problems that guide solve processes for ingredient selection, portion sizing, and preparation sequencing. Accordingly, vector-based generation allows meal output 922 to simultaneously account for nutritional needs, user activity state, operational timing, and culinary quality, resulting in meals that are both personalized and contextually adaptive.

Meal output 922 may be provided to a user device for presentation to the user of the user device (e.g., via a GUI). The GUI may allow for the user to select meal output 922 for meal generation fulfillment. In certain embodiments, upon termination of the session (e.g., if the user selects a generated meal or provides an indication that the user is no longer interested in having the system generate a meal) the session payload may be deleted to avoid storage of unnecessary and outdated session payloads. The meals generated may be utilized as feedback for optimization of meal generation seeds, in accordance with the techniques described herein.

### Graphical User Interface Example

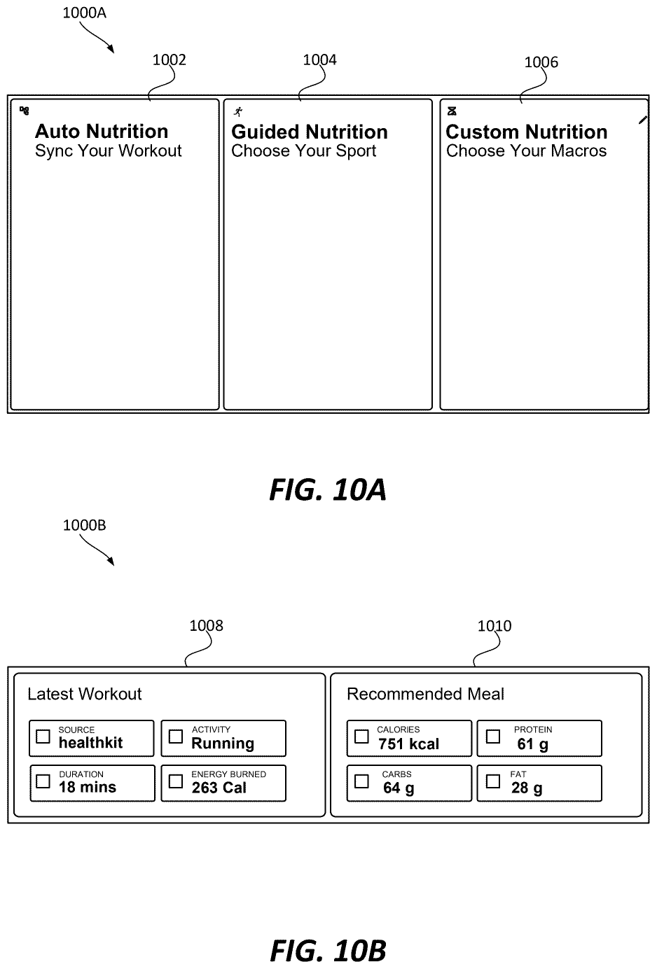

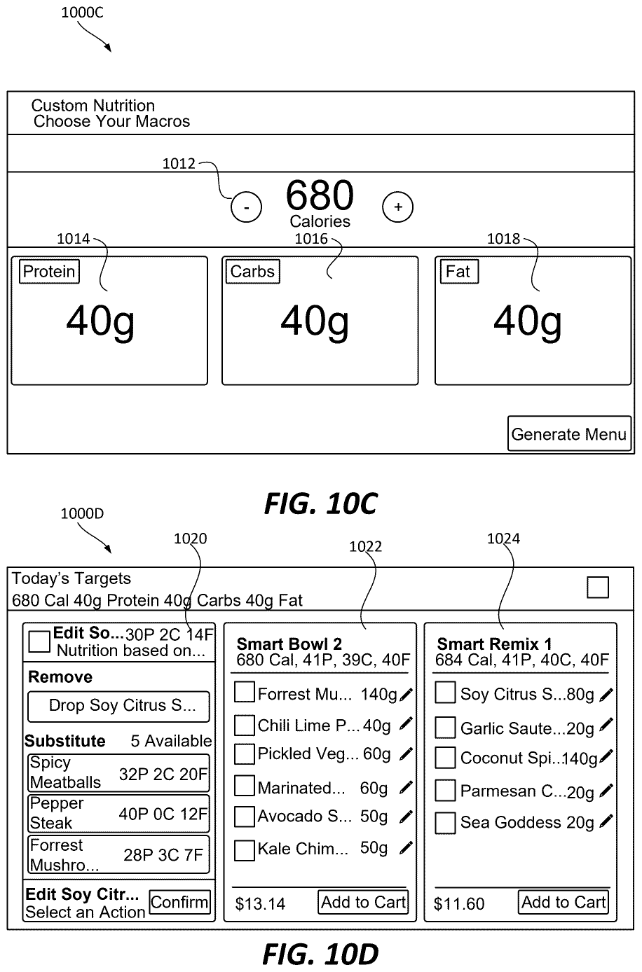

FIGS. 10A-D illustrate example GUIs for meal generation, in accordance with certain embodiments. FIG. 10A illustrates GUI 1000A, which may be a GUI configured for a user to select the style of meal generation to request from platform 102. Thus, for example, GUI 1000A may include selection 1002, selection 1004, and selection 1006. Selection 1002 may be meal generation selection where platform 102 automatically receives a user's macro information (e.g., fitness tracking data) and generates an appropriate meal from such data. Selection 1004 may be meal generation selection where a user provides inputs as to the user's biometrics or exercise history to various GUIs and platform 102 utilizes such data to generate a meal. Selection 1006 may be meal generation selection where a user provides inputs indicating the granular breakdown of nutrients that should be provided by a generated meal.

FIG. 10B illustrates GUI 1000B, which may be a GUI configured to indicate data related to the user's workout and the recommended macro nutrients to be provided by a generated meal based on the data of the user's workout. Portion 1008 of GUI 1000B indicates details from the latest tracked workout of the user's, which may be based on data received from any technique described herein and may be utilized as the basis or as an input for generation of a session payload. Portion 1010 may be the macronutrient recommendation for a meal generated based on the user's workout data.

FIG. 10C illustrates GUI 1000C, which may be a GUI that includes indicators 1014, 1016, and 1018. Indicators 1014, 1016, and 1018 may be configured to indicate macronutrient targets for meal generation. GUI 1000C may also include manipulator 1012. Manipulator 1012 may, in certain embodiments, be a GUI element that allows a user to increase or decrease certain inputs (e.g., macronutrient targets) utilized to create a session payload and/or utilized in meal generation. Thus, for example, manipulator 1012 may allow a user to adjust the nutritional content targets (e.g., carbohydrates, protein, and/or other such nutritional content) of a generated meal. Additionally or alternatively, in certain embodiments, manipulator 1012 may be utilized to adjust the number of ingredients of a certain category and/or another such aspect of meal generation. After confirmation of the adjustment, updated data may be provided to platform 102 and updated meals may be accordingly generated.

FIG. 10D illustrates GUI 1000D, which may be a GUI that includes substitution portion 1020 and generated meals 1022 and 1024. Substitution portion 1020 may allow a user to substitute one or more ingredients from a selected meal (e.g., generated meal 1022 or 1024). Of note, generated meals 1022 or 1024 may be meals generated according to any techniques described herein. GUI 1000D may output data of generated meals 1022 and 1024 to a user of the user device containing GUI 1000D. Substitution portion 1020 may allow a user to select one or more ingredients of generated meals 1022 or 1024 and replace such ingredients with an alternative.

After confirmation of the adjustment, updated data may be provided to platform 102 and updated meals may be accordingly generated in a manner where macronutrient elements are still aligned. Alternatively, the GUI may allow for a user to select their preferred ingredients from a list or a graphical representation. After confirmation of the selection, updated data may be provided to platform 102 and the meal generation module may tune the portions (e.g., number of grams) of the selected ingredients to the macronutrient targets. If targets are physically infeasible within tolerances (e.g., a low-fat target with many high-fat ingredient selections), platform 102 may generate a meal that is the closest feasible solution with explicit feedback indicating the reasons for the selections.

### Controller Example

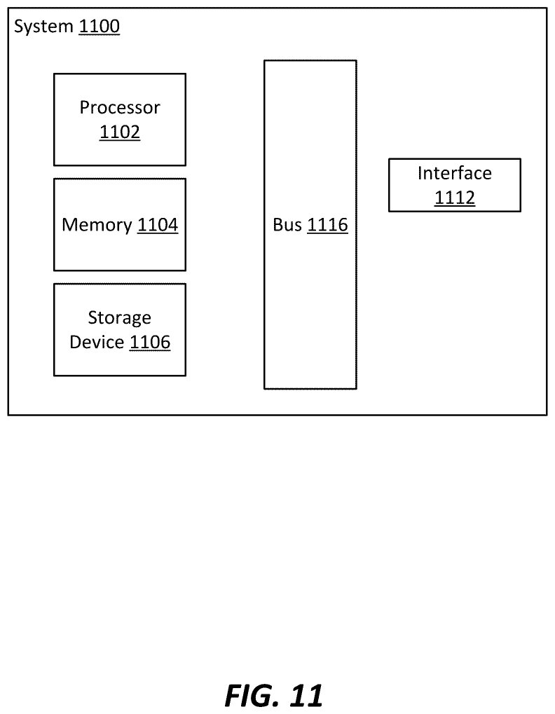

FIG. 11 illustrates a block diagram of an example computing system, in accordance with certain embodiments. According to various embodiments, a system 1100 suitable for implementing embodiments described herein includes a processor 1102, a memory module 1104, a storage device 1106, an interface 1112, and a bus 1116 (e.g., a PCI bus or other interconnection fabric.) System 1100 may operate as a variety of devices such as a server system such as an application server and a database server, a client system such as a laptop, desktop, smartphone, tablet, wearable device, set top box, etc., or any other device or service described herein.

Although a particular configuration is described, a variety of alternative configurations are possible. The processor 1102 may perform operations such as those described herein. Instructions for performing such operations may be embodied in the memory 1104, on one or more non-transitory computer readable media, or on some other storage device. Various specially configured devices can also be used in place of or in addition to the processor 1102. The interface 1112 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed embodiments may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

### CONCLUSION

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various embodiments have been described herein, it should be understood that they have been presented by way of example only, and not limitation. For example, some techniques and mechanisms are described herein in the context of fulfillment. However, the disclosed techniques apply to a wide variety of circumstances. Particular embodiments may be implemented without some or all of the specific details described herein. In other instances, well known process operations have not been described in detail in order not to unnecessarily obscure the techniques disclosed herein. Accordingly, the breadth and scope of the present application should not be limited by any of the embodiments described herein, but should be defined only in accordance with the claims and their equivalents.

1-10. (canceled)

11. A system comprising:
a user database, configured to store user template data associated with a first user;
a configuration database, configured to store meal generation templates;
a communications module;
a session module, configured to determine individual session payloads for individual meal generation indications;
a meal generator module, wherein the system is configured to:
receive, with the communications module and from a user device associated with the first user, first user data comprising a first meal generation indication;
access, with the session module and based on receiving the first meal generation indication, the user database to obtain first user template data associated with the first user;
determine, with the session module and based on the first user template data and the first user data, a first session payload associated with the first meal generation indication, the first session payload configured to allow for subsequent selection of ingredient categories;
communicate the first session payload to the meal generator module;
select, with the meal generator module and based on receiving the first session payload, a first meal generation template from the configuration database, the first meal generation template configured to specify one or more ingredient categories for subsequent selection of ingredients;
generate, with the meal generator module and based on the first session payload, first meal data in accordance with the first meal generation template, wherein the generating the first meal data comprises:
selecting, based on the first meal generation template, one or more individual ingredients; and
determining one or more preparation aspects for the individual ingredients;
communicate, with the communications module, the first meal data to the user device;
receive, with the communications module from the user device, second user data indicating a user selection of the first meal data; and
communicate, with the communications module, the first meal data to a meal preparation system to cause the meal preparation system to prepare a first meal.

12-13. (canceled)

14. The system of claim 11, wherein the system is further configured to:
delete the first session payload after communication of the first meal data to the meal preparation system.

15. The system of claim 11, wherein the meal preparation system comprises an autonomous meal preparation robot.

16. The system of claim 15, wherein the system is further configured to:
receive, with the communications module, configuration data indicating a current configuration of the autonomous meal preparation robot, wherein the first session payload is determined based further on the configuration data.

17. The system of claim 11, wherein the system is further configured to:
receive, with the communications module and from the user device, first fitness data; and
store, within the user database, the first fitness data, wherein the determining the first session payload is further based on the first fitness data.

18. The system of claim 11, wherein the first meal generation template comprises:
a first category target associated with a first ingredient category; and
a second category target associated with a second ingredient category.

19. The system of claim 11, wherein the system is further configured to:
receive, with the communications module from the user device, second user data indicating a user rejection of the first meal data;
select, based on the user rejection, a second meal generation template from the configuration database;
generate, with the meal generator module and based on the first session payload, second meal data in accordance with the second meal generation template; and
communicate, with the communications module, the second meal data to the user device.

20. The system of claim 11, wherein the system is further configured to:
select a second meal generation template from the configuration database;
generate, with the meal generator module and based on the first session payload, second meal data in accordance with the second meal generation template; and
communicate, with the communications module, the second meal data to the user device along with the first meal data.

21. The system of claim 11, wherein the first session payload is specifically generated in response to the first meal generation indication.

22. The system of claim 17, wherein the first fitness data comprises biometric measurements, activity tracking data, and/or sleep tracking data.

23. The system of claim 22, wherein the first user template data is of a first data shape, the first fitness data is a second data shape, and wherein the first session payload is a third data shape compatible for ingestion by the meal generator module.

24. The system of claim 23, wherein the first data shape and the second data shape are incompatible for ingestion by the meal generator module.

25. The system of claim 11, wherein the first session payload does not specify ingredients or ingredient categories.

26. The system of claim 25, wherein the first meal generation template does not specify specific ingredients.

27. The system of claim 11, wherein the selecting the first meal generation template comprises determining the first meal generation template with the meal generator module.

28. The system of claim 11, wherein the system is further configured to:
receive first ingredient data, wherein the first meal data is generated based further on the first ingredient data.

29. The system of claim 28, wherein first ingredient data comprises inventory data indicating availability of the ingredient.

30. The system of claim 28, wherein the first ingredient data comprises data directed to caloric density, macro and/or micronutrient content, and/or freshness status.

31. The system of claim 30, wherein the first meal data is generated based on the caloric density and/or macro and/or micronutrient content of the first ingredient data.

32. The system of claim 11, wherein the system is further configured to:
receive, with the communications module and from a user device associated with the first user, second user data comprising a second meal generation indication at a second time different from preparation of the first meal during a first time;
access, with the session module and based on receiving the second meal generation indication, the user database to obtain second user template data associated with the first user;
determine, with the session module and based on the second user template data and the second user data, a second session payload associated with the second meal generation indication;
communicate the second session payload to the meal generator module;
select, with the meal generator module and based on receiving the second session payload, a second meal generation template from the configuration database;
generate, with the meal generator module and based on the second session payload, second meal data in accordance with the second meal generation template, wherein the generating the second meal data comprises:
selecting, based on the second meal generation template, one or more individual ingredients; and
determining one or more preparation aspects for the individual ingredients; and
communicate, with the communications module, the second meal data to a meal preparation system to cause the meal preparation system to prepare a second meal.
